(19) United States
(12) Patent Application Publication
(10) Pub. No.: US 2013/0124278 A1
(43) Pub. Date: May 16, 2013

(54) METHODS, APPARATUS AND SYSTEMS FOR PROVIDING A MULTI-PURPOSE TASK COMPLETION PLATFORM

(71) Applicant: Tarek Najm, Kirkland, WA (US)

(72) Inventor: Tarek Najm, Kirkland, WA (US)

(73) Assignee: QA Channel, Inc., Kirkland, WA (US)

(21) Appl. No.: 13/297,087

(22) Filed: Nov. 15, 2011

(51) Int. Cl. G06Q 30/02

(52) U.S. Cl. 705/14.11

(57) ABSTRACT

A computer-implemented method of sourcing electronic tasks is disclosed. The method includes receiving customized electronic tasks, each customized electronic task being customized for a content managing entity. The method also includes identifying a plurality of users that selected to participate in receiving customized electronic tasks. The method further includes communicating one or more of the customized electronic tasks to at least one of the identified plurality of users. A method of consuming electronic tasks is also disclosed. The method includes displaying indicators of customized electronic tasks to a user, receiving a user selection of one of the customized electronic tasks, and generating feedback information regarding the selected customized electronic task.

### BACKGROUND

Embodiments of the present invention relate to methods, apparatus and systems for providing a multi-purpose task completion platform, and in particular to acquiring and distributing electronic tasks to end users and incentivizing systematic user-engagement with those tasks.

Various techniques are currently used to acquire information from and/or about people in society. For example, surveys may be communicated to individuals by telephone, mail, online, or the like, questioning participants on their preference for a particular product, service, government decision, police preference, etc. While potentially providing an easy way to acquire information from people, surveys are often fraught with deficiencies such as lack of response, inaccurate responses, etc. One technique for reducing such deficiencies is to provide a financial incentive for participating in such surveys; however, deficiencies such as poor quality responses may still exist since the participant often needs to merely provide a response to receive the financial incentive.

Turning to advertising models, various tools are currently used to expose consumers to products and services, and more specifically to the brand by which such products and services are distributed or provided under. In some cases, companies may push advertising including videos, graphical images, and/or text to consumers via one or more of many mediums. For example, companies may purchase web banners on web sites such that their advertisement gets displayed to a user visiting the web site. For another example, companies may purchase or cause advertising windows to be displayed to a user (e.g., via a pop-up window) in response to a user unwittingly selecting a particular URL. Such advertising techniques, while not preferred by most users of personal computers, have generally been accepted or at least tolerated, perhaps because the relatively large size of personal computer displays provides enough visual display space to enable a user to consume the desired content while ignoring the advertisements displayed at the peripheries. More recently, portable handheld devices such as smartphones have become increasingly popular. However, user tolerance for pop-up windows and web banners on such portable handheld devices is at a minimum, perhaps because screen real estate is at a premium, or for some other reasons. Regardless of the basis for the lack of user tolerance to advertising via portable handheld devices, the result remains that companies have a difficult time exposing consumers to products or services through portable handheld devices, much less generating brand loyalty or receiving (constructive) user feedback concerning the advertised brand.

### BRIEF SUMMARY

Embodiments of the present invention overcome some or all of the aforementioned deficiencies in the related art and provide additional advantages, many of which are described herein. Herein, various embodiments for creating a multi-purpose task completion platform are disclosed. The platform uses customized electronic tasks that may be generated by one or more of a variety of entities, such as creative agencies, pollsters, advertisers, etc., where the customized tasks are communicated to users who have selected to receive such tasks. The tasks may be one or more of a variety of tasks, such as questions, surveys, games, contests, etc. The entities may incentivize user engagement with the tasks in a number of ways, such as by rewarding the users upon completion of the task, providing loyalty cards to the users such that increased task completion results in increased reward distribution, increasing the quality of tasks available to the user upon completion of a certain number of tasks, etc. As a result, the marketplace facilitates mutually beneficial transactions, wherein entities desiring to acquire or distribute information (such as market researchers, pollsters, advertising agencies, etc.) may do so not only in a single instance with an individual but rather in a systematic fashion whereby the entity may repeatedly acquire information from or distribute information to the same individual, and individuals may obtain increasing rewards that may be redeemable for consumption by the individual, such as individual-selected goods or services. The platform is multi-purpose in that a variety of different types of entities may utilize the platform to communicate with willing users. For example, this may be for the purpose of acquiring information from users, such as user interests, user opinions, etc. For another example, this may be for the purpose of advertising or otherwise distribution information to users, such as in accordance with an advertising campaign, to create brand awareness, or the like.

In some embodiments, game mechanics and other interactive features such as branded surveys are used to attract, retain, and reward consumers. In doing so, consumers become engaged in simple tasks using various computing devices and especially portable computing devices such as smart phones, as portable computing devices tend to be application driven and by their nature facilitate multiple instances of short-term use throughout a day. For businesses, the disclosed embodiments attract user attention to products, brands, causes and services in a tasteful manner, and build long-term relationships with consumers. For users, the disclosed embodiments provide a simple, fun, and rewarding experience.

As part of the multi-purpose task completion platform, methods, apparatus, and systems for acquiring, distributing and managing electronic tasks are disclosed. In one embodiment, a method of sourcing electronic tasks is disclosed. The method includes obtaining, by one or more computer systems, customized electronic tasks, each electronic task being customized by or for a corresponding content managing entity. The method also includes identifying a plurality of users that selected to participate in receiving customized electronic tasks. The method further includes communicating one or more of the customized electronic tasks to at least one of the identified plurality of users, and receiving feedback information indicating an engagement with the customized electronic tasks by the users for determining a reward to be issued to the users.

In some embodiments, each electronic task may be customized to promote a brand of goods or services. In other embodiments, the electronic task may be selected from the group consisting of: a question, a survey, an action, and a game. In at least one embodiment, the method may further include acquiring demographic information concerning the plurality of users, where the electronic tasks may be communicated to the identified users based on the demographic information concerning the identified users.

In another embodiment, a computer readable storage medium is disclosed that, when executed, causes a computing device or system of computing devices to perform operations. The operations include displaying one or more indicators of customized electronic tasks to a user, the user having selected to participate in receiving customized electronic tasks. The operations also include receiving a user selection of one of the customized electronic task indicators, and generating feedback information regarding the selected customized electronic task, the feedback information indicating an engagement with the selected customized electronic task by the user.

In some embodiments, the operations may further include displaying a request for login information and receiving login information from the user, the login information identifying the user from a plurality of users. In this case, the customized electronic tasks may be displayed based on the login information.

In other embodiments, system for sourcing electronic tasks is disclosed. The system includes a processor operable to identify a plurality of users that selected to participate in receiving customized electronic tasks, each customized electronic task being customized for a corresponding content managing entity. The system also includes a communication interface operable to receive customized electronic tasks, and a storage element operable to store the customized electronic tasks. The communication interface may be further operable to communicate one or more of the customized electronic tasks to at least one of the identified plurality of users.

For a more complete understanding of the nature and advantages of embodiments of the present invention, reference should be made to the ensuing detailed description and accompanying drawings. Other aspects, objects and advantages of the invention will be apparent from the drawings and detailed description that follows. However, the scope of the invention will be fully apparent from the recitations of the claims.

### BRIEF DESCRIPTION OF THE DRAWINGS

FIG. 1 is a simplified system illustrating an environment operable to implement aspects of one or more of the various embodiments disclosed herein in accordance with a first embodiment.

FIG. 2 is a simplified system illustrating an environment operable to implement aspects of one or more of the various embodiments disclosed herein in accordance with a second embodiment.

FIG. 3A is a flowchart depicting a method of sourcing customized electronic tasks in accordance with at least one embodiment.

FIG. 3B is a flowchart depicting a method of receiving customized electronic tasks in accordance with at least one embodiment.

FIG. 4 is a flowchart depicting a method of consuming customized electronic tasks in accordance with at least one embodiment.

FIG. 5A illustrates a computer generated interface for selecting a type of electronic task to be generated in accordance with at least one embodiment.

FIG. 5B illustrates a computer generated interface for selecting a template to be used in generating a customized electronic task in accordance with at least one embodiment.

FIG. 5C illustrates a computer generated interface for providing customization information to be used in generating a customized electronic task in accordance with at least one embodiment.

FIG. 6 illustrates a computer generated interface for creating rewards to be disbursed to users in accordance with at least one embodiment.

FIG. 7A illustrates a computer generated interface for consuming customized electronic tasks according to a first embodiment.

FIG. 7B illustrates a computer generated interface for editing user preferences in accordance with at least one embodiment.

FIG. 7C illustrates a computer generated interface for viewing a reward summary in accordance with at least one embodiment.

FIG. 7D illustrates a computer generated interface for viewing earned coupons in accordance with at least one embodiment.

FIG. 7E illustrates a computer generated interface for viewing level achievements and point achievements in accordance with at least one embodiment.

FIG. 8A illustrates a computer generated interface for consuming customized electronic tasks according to a second embodiment.

FIG. 8B illustrates a computer generated display showing a survey-type customized electronic task in accordance with at least one embodiment.

FIG. 8C illustrates a computer generated display showing a thank you screen and an option to engage in an additional customized electronic task in accordance with at least one embodiment.

FIG. 8D illustrates a computer generated display showing an additional customized electronic task in accordance with at least one embodiment.

FIG. 8E illustrates a computer generated interface for viewing user information in accordance with at least one embodiment.

FIG. 8F illustrates a computer generated interface for viewing and setting user preferences in accordance with at least one embodiment.

FIG. 8G illustrates a computer generated display showing indicators of messages available for display in accordance with at least one embodiment.

FIG. 8H illustrates a computer generated display showing details of a selected message in accordance with at least one embodiment.

### DETAILED DESCRIPTION

Embodiments of the invention are generally directed to methods, apparatus and systems for providing a multi-purpose task completion platform, and in particular to acquiring and distributing electronic tasks to end users and incentivizing systematic user-engagement with those tasks. In some embodiments, a server or system may be provided in which content managing entities desiring to acquire information from users and/or distribute information to users (e.g., creative agencies, pollsters, surveyors, advertisers, etc.), may generate customized electronic tasks.

The electronic tasks may be any suitable tasks that require and encourage a user such as a consumer to engage in the task. There may be various types and levels of engagement, where the type of engagement depends on the type of task, and the level of engagement depends on the consumer's interaction with the task. Various types of tasks may include questions that a content managing entity would like answered by an individual, surveys that the content managing entity would like to be filled out by the individual, games which the content managing entity may provide to the user, etc. While the tasks may be useful for acquiring information such as an individual's preference for one product over another, opinion on a government policy, interest in travel to a particular foreign country, or the like, the tasks may also be useful for distributing information and/or advertising a brand. Advertising may be done in a variety of ways, including directing questions to the products associated with a brand, including brand images in the advertisement, and the like.

The content managing entities may use the system to create the customized electronic tasks. For example, the system may run applications that operate to create user interfaces with which the content managing entities interact with. The user interfaces may be accessible to the content managing entities in any number of ways. In one example, the content managing entities may use their own computing device such as a desktop computer to remotely access the system and utilize the user interfaces provided by the system.

In creating customized electronic tasks, various techniques for creating tasks may be used. In one embodiment, templates may be stored by the system and accessed by the content managing entities. For example, a template for a question-type of advertisement may provide a particular spatial location for which a question will be presented to a user and a particular spatial location for which an answer may be submitted by the user. The template may also include a particular size and location of an image that the content managing entity can upload to the system, such as an image illustrating a logo associated with the content managing entity. The content managing entity may then customize the template in a variety of ways. For example, the content managing entity may upload its logo, enter the content of the question, upload images associated with possible answer choices, and the like. In another embodiment, the electronic tasks may be generated without the use of a template. For example, a content managing entity may create a computer game (such as a racing game or a tiles-type game where a user has to re-order the tiles to form an image). The computer game can be created in its entirety by the content managing entity and uploaded to the system for distribution to consumers. Some examples of brand placement include adding corporate logos to entities in the game, such as a car in the racing game or on the tiles in the tiles game.

In addition to providing an interface for content managing entities to generate customized electronic tasks, the system may also manage accounts and task distribution campaigns associated with the content managing entities. For example, content managing entities may place funds into their account for disbursement to consumers and, in some cases, to administrators of the system. Content managing entities may also manage their task distribution campaigns by, for example, viewing statistics associated with their electronic tasks. The system may generate various statistics for the content managing entities, such as how many users a particular task has been disseminated to, how many users have engaged with the task, how many funds have been disbursed to users, etc.

The system may also be operable to disseminate customized electronic tasks to consumers. The tasks are generally not communicated to any consumer, but rather are communicated only to consumers who have indicated a desire to receive the tasks. For example, this may be consumers who have registered with the system to receive the tasks, downloaded applications operable to receive the tasks, or the like. In addition to communicating tasks only to consumers desiring to receive them, the system may also perform additional forms of targeted task dissemination. For example, the system may acquire demographics of users that have registered, and subsequently use such user demographics to selectively communicate tasks to users.

Consumers may interact with the system to receive customized electronic tasks in a variety of ways. In one embodiment, a consumer may have an electronic computing device such as a smart phone. The consumer may install an application on their smart phone that is operable to interact with the system by, for example, sending user information to the system, receiving customized electronic tasks from the system, and communicating indications as to the consumer's level of engagement with received tasks. In another embodiment, a consumer may have an account with a social networking service such as Facebook™, and a similar application may be installed and executed as an application that integrates with the social networking service. The consumer may then use the application via the social networking service to similarly interact with the system. In yet another embodiment, a consumer may access the functionality of the system by engaging a web site or application hosted and/or executed by the system.

Regardless of how the consumer interacts with the system, the consumer may be presented with a graphical interface in which customized electronic tasks may be selected by the user and engaged by the user. In engaging the task, the consumer may perform a variety of actions, such as selecting a favorite product, playing a game, etc. The graphical interface may provide additional functionality to the user, such as enabling the user to add, edit, or remove user information, user preferences, etc.

In some embodiments, the system may also implement a reward system, where the reward system may encourage consumers to engage the electronic tasks. In accordance with the reward system, users may be provided some type of reward in return for their engagement with a task. Various types of rewards may be awarded to the consumers, such as points, coupons, sweepstakes entries, etc. The value from (i.e., funding for) the reward may be provided by various entities, including the content managing entity that created a consumed task, or from administrators of the system.

Multiple reward systems may simultaneously operate with one another. For example, one reward system may be applicable only to a certain content managing entity. In this case, the consumer may earn points and rewards only from the consumers interaction with tasksprovided by that particular content managing entity. An additional reward system may be applicable to all content managing entities. For example, the additional reward system may be provided by the system administrators. In this case, the consumer may earn points and rewards as a result of interaction with tasks provided by any content managing entity.

One or more of the reward systems may also implement levels, where a user may increase their level upon satisfying various conditions. For example, a user may level up once a certain number of points have been earned. Upon increasing their level, a user may obtain some sort of benefit. For example, additional tasks may be made available to the user, where the tasks are not available to users at a lower level. For another example, a user with a higher level may earn a greater number of points for engaging a particular tasks compared to a user with a lower level.

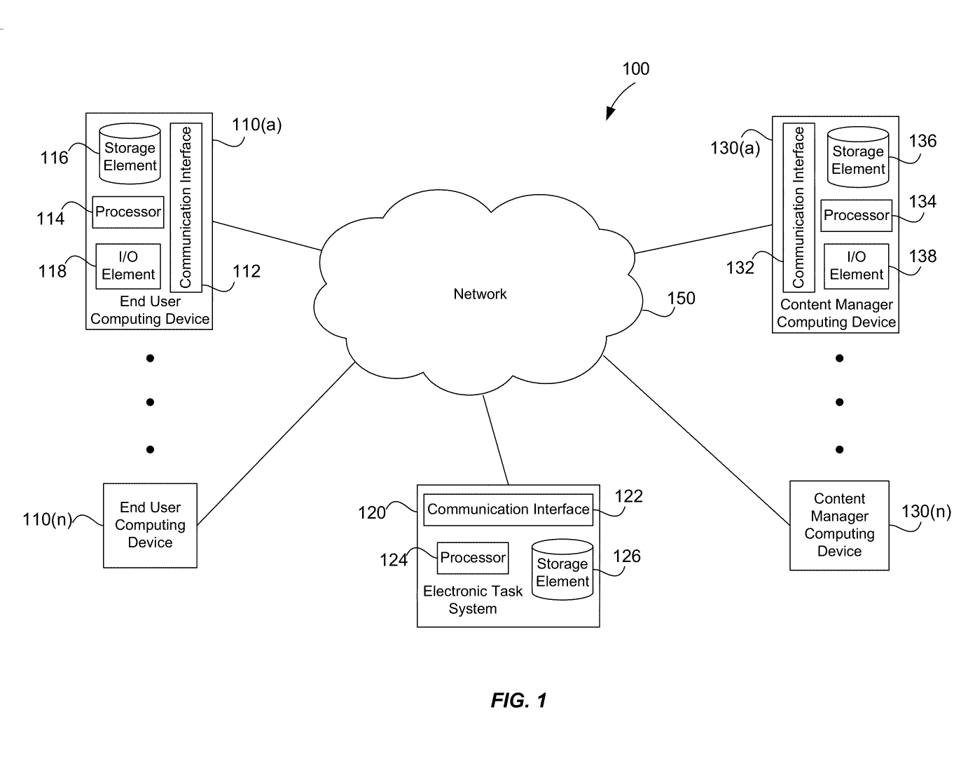

Various aspects of systems, methods, and apparatuses discussed above are further described below with reference to FIGS. 1 to 8H. FIGS. 1 to 8H are illustrative examples providing a more in depth understanding of various embodiments of the present invention, but are not intended to limit the scope of the claims in any way. FIGS. 1 to 8H begin with a description of systems in which embodiments of the present invention may be implemented.

FIG. 1 is a simplified system 100 illustrating an environment operable to implement aspects of one or more of the various embodiments disclosed herein in accordance with a first embodiment. System 100 includes a plurality of end user computing devices 110(a)-110(n), an interactive advertising system 120, and a plurality of content manager computing devices 130(a)-130(n). The number of end user computing devices 110 may be one or greater than one, and the number of content manager computing devices 130 may be the same or different than the number of end user computing devices 110. In some embodiments, electronic task system 120 may be a system or network of devices operable to perform one or more of the functions described herein. Each of these elements of system 100 may be operable to communicate either directly or indirectly with one another using any suitable communication infrastructure. In one embodiment, these elements may communicate with one another via network 150.

End user computing devices 110(a)-110(n) may include any suitable electronic computing devices, such as a mobile phone, a personal digital assistant (PDA), a handheld or portable device (iPhone, Blackberry, etc.), a notebook, personal computer, note pad or other electronic device configured for wired or wireless communication. At least some of end user computing devices 110(a)-110(n) may be associated with end users that have selected to participate in receiving customized electronic tasks. An end user computing device 110(a) may then be used by an end user to receive and engage with the electronic task.

End user computing devices 110(a)-110(n) may include any suitable components typically found in such electronic device necessary to perform the operations discussed herein. In one embodiment and as illustrated in FIG. 1, an end user computing device 110(a) includes a communication interface 112, a processor 114, a tangible non-transitory computer readable storage element 116, and an input/output element 118. Communication interface 112 is any suitable interface or interfaces operable to enable communication between end user computing device 10(a) and other elements of system 100, such as electronic task system 120. Processor 114 is any suitable computing processor or processors operable to execute instructions that cause end user computing device 110(a) to perform one or more of the operations discussed herein. For example, processor 114 may execute software code stored in one or more storage elements such as storage element 116. Storage element 116 may be any storage element or storage elements suitable for storing data, software code, and other information used by end user computing device 110(a). For example, storage element 116 may include one or more of random access memory (RAM), read only memory (ROM), electrically-erasable programmable read only memory (EEPROM), a hard disk, an optical disk, etc. Input/output element 118 may include one or more elements for receiving input from a user and providing outputs to the user. For example, input/output element 118 may include a keypad, a display, a touch screen, or a combination thereof.

Electronic task server or system 120 may be any suitable electronic computing device or system of electronic computing devices operable to acquire and disseminate electronic tasks. In some embodiments, electronic task system 120 may acquire customized electronic tasks from one or more of content manager computing devices 130(a)-130(n). Electronic task system 120 may then be operable to communicate the customized electronic tasks to users via user computing devices 110(a)-110(n).

Electronic task system 120 may include any suitable components typically found in such systems necessary to perform the operations discussed herein. In one embodiment and as illustrated in FIG. 1, electronic task system 120 includes a communication interface 122, a processor 124, and a tangible non-transitory computer readable storage element 126. Communication interface 122 is any suitable interface or interfaces operable to enable communication between electronic task system 120 and other elements of system 100, such as one or more of end user computing devices 110(a)-110(n), and/or one or more of content manager computing devices 130(a)-130(n). Processor 124 is any suitable computing processor or processors operable to execute instructions that cause electronic task system 120 to perform one or more of the operations discussed herein. For example, processor 124 may execute software code stored in one or more storage elements such as storage element 126. Storage element 126 may be any storage element or storage elements suitable for storing data, software code, and other information used by electronic task system 120. For example, storage element 126 may include one or more of random access memory (RAM), read only memory (ROM), electrically-erasable programmable read only memory (EEPROM), a hard disk, an optical disk, etc.

Content manager computing devices 130(a)-130(n) may be any suitable electronic computing devices, such as a mobile phone, a personal digital assistant (PDAs), a handheld or portable device (iPhone, Blackberry, etc.), a notebook, personal computer, note pad or other electronic device configured for wired or wireless communication. Content manager computing devices 130(a)-130(n) may be associated with a branding manager including, for example, creative agencies, pollsters, surveyors, advertisers, agencies, distribution partners, business managers, administrators, or other entities involved in the creation and distribution of customized electronic tasks. Content manager computing devices 130(a)-130(n) may be used by such entities, for example, to generate and customize electronic tasks via electronic task system 120.

Content manager computing devices 130(a)-130(n) may include any suitable components typically found in such electronic device necessary to perform the operations discussed herein. In one embodiment and as illustrated in FIG. 1, a content manager computing device 130(a) includes a communication interface 132, a processor 134, a tangible non-transitory computer readable storage element 136, and an input/output element 138. Communication interface 132 is any suitable interface or interfaces operable to enable communication between content manager computing device 130(a) and other elements of system 100, such as electronic task system 120. Processor 134 is any suitable computing processor or processors operable to execute instructions that cause content manager computing device 130(a) to perform one or more of the operations discussed herein. For example, processor 134 may execute software code stored in one or more storage elements such as storage element 136. Storage element 136 may be any storage element or storage elements suitable for storing data, software code, and other information used by content manager computing device 130(a). For example, storage element 136 may include one or more of random access memory (RAM), read only memory (ROM), electrically-erasable programmable read only memory (EEPROM), a hard disk, an optical disk, etc. Input/output element 138 may include one or more elements for receiving input from an entity such as a creative agency and providing outputs to the entity. For example, input/output element 138 may include a keypad, a display, a touch screen, or a combination thereof.

Network 150 is any suitable network for enabling communications between various entities, such as between end user computing devices 110(a)-110(n), electronic task system 120, and content manager computing devices 130(a)-130(n). Such a network may include, for example, a local area network, a wide-area network, a virtual private network, the Internet, an intranet, an extranet, a public switched telephone network, an infrared network, a wireless network, a wireless data network, a cellular network, or any other such network or combination thereof. The network may, furthermore, incorporate any suitable network topology. Examples of suitable network topologies include, but are not limited to, simple point-to-point, star topology, self organizing peer-to-peer topologies, and combinations thereof. Components utilized for such a system may depend at least in part upon the type of network and/or environment selected. Network 150 may utilize any suitable protocol, such as TCP/IP, OSI, FTP, UPnP, NFS, CIFS, and AppleTalk. Communication over the network may be enabled by wired or wireless connections, and combinations thereof.

System 100 in certain embodiments is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 1. Thus, the depiction of system 100 in FIG. 1 should be taken as being illustrative in nature, and not limiting to the scope of the disclosure.

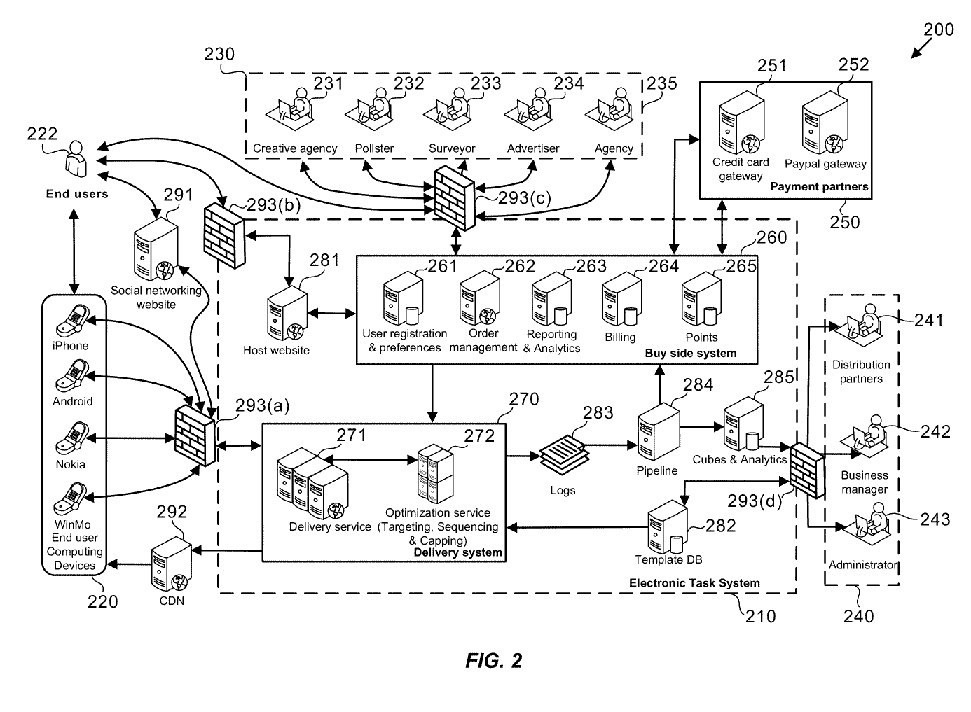

FIG. 2 is a simplified system 200 illustrating an environment operable to implement aspects of one or more of the various embodiments disclosed herein in accordance with a second embodiment. System 200 includes an electronic task system 210, end user computing devices 220 associated with one or more end users 222, content managing entities 230, system managers 240, and payment partners 250, among other elements.

Electronic task system 210 may generally be operable to provide an interface to content managing entities 230 whereby content managing entities 230 may create customized electronic tasks to be communicated to end users 222, generate campaigns in which certain electronic tasks are selectively communicated to targeted users, and view reports providing a status on the campaigns and other information related to the provision and dissemination of electronic tasks. Electronic task system 210 may also be operable to communicate the electronic tasks customized by content managing entities 230 to end users 222, and receive feedback information from electronic devices associated with the end users 222 in response to the end users 222 engaging or otherwise consuming the electronic tasks. Further, electronic task system 210 may be operable to provide an interface to system managers 240 whereby system managers 240 may generate and manipulate templates of electronic tasks used by content managing entities 230 in the creation of customized electronic tasks and may analyze, consume, and/or configure data cubes and analytic information regarding electronic task system 210. In some embodiments, electronic task system 210 may correspond to electronic task system 120 discussed with reference to FIG. 1.

End users 222 may be any consumer or other user of electronic task system 210. At least some of the end users 222 may select to participate in receiving customized electronic tasks. End users 222 may interact with electronic task system 210 in one or more of a variety of fashions. For example, end users 222 may use an electronic computing device such as an end user computing device 220 to interact with electronic task system 210, where end user computing device 220 may be similar to an end user computing device 110(a) discussed with referenced to FIG. 1. The end user computing devices 220 may communicate directly with electronic task system 210 or, in some embodiments, through a firewall 293(a). For another example, end users 222 may interact with electronic task system 210 via a social networking web site 291 or other social networking service interface. The social networking web site 291 may communicate directly with electronic task system 210 or, in some embodiments, through firewall 293(a). For yet another example, users may interact with electronic task system 210 via a host web site 281 that is hosted by interaction advertisement system 210. End user 222 may communicate directly with host web site 281 or, in some embodiments, through a firewall 293(b).

Engagement with electronic task system 210 by end users 222 may include downloading and/or executing applications operable to interface with electronic task system 210, receiving customized electronic tasks, engaging the customized electronic task, completing the customized electronic task, and/or communicating feedback information to electronic task system 210, where feedback information may include a status of the level of engagement with the customized electronic task.

Content managing entities 230 may be any entity that desiring to generate and communicate customized electronic tasks to end users 222. For example, content managing entities 230 may include creative agencies 231, pollsters 232, surveyors 233, advertisers 234, and/or agencies 235. Each content managing entity 230 may be associated with an electronic computing device (such as a content manager computing device 130(a) discussed with reference to FIG. 1) by which the content managing entity 230 may interact with electronic task system 210 as discussed herein. Content managing entities 230 may communicate directly with electronic task system 210 via their electronic computing device or, in some embodiments, through a firewall 293(c).

System managers 240 may be any entity that operates to manage electronic task system 210. For example, system managers 240 may include distribution partners 241, business managers 242, and/or administrators 243. Each system manage 240 may be associated with an electronic computing device (such as a content manager computing device 130(a) discussed with reference to FIG. 1) by which the system manager 240 may interact with electronic task system 210 as discussed herein. System managers 240 may communicate directly with electronic task system 210 via their electronic computing device or, in some embodiments, through a firewall 293(d).

Payment partners 250 may be an entity that operates to transfer value between entities, such as between content managing entities 230, end users 222, and system managers 240. Value may be transferred in a variety of ways. For example, end users 222 may have an account associated with a payment partner 250. Monetary value may then be credited to the account by electronic task system 210 on behalf of a content managing entity 230. Monetary value may be credited to the user for a variety of purposes, such as the users' engagement with an electronic task. For another example, system managers 240 may have an account associated with a payment partner 250. Monetary value may then be credited to the account by electronic task system 210 on behalf of content managing entity 230. Monetary value may be credited to system manager 240 for a variety of purposes, such as to fund an account for distribution to end users 222. Payment partners 250 may include one more gateways to payment processing systems, such as a credit card gateway 251, a PayPal™ gateway, etc. The financial accounts of end users 222, content managing entities 230, and/or system managers 240, may be accessed via such gateways, and transactions may be processed via such gateways.

Electronic task system 210 may include one or more computing elements for acquiring, distributing and managing electronic tasks. Buy side system 260 is a system operable to provide an interface via which content managing entities 230 may interact with electronic task system 210. Buy side system 260 may include any suitable components operable to perform the operations discussed herein with respect to buy side system 260, such as computer processors, storage elements, communication interfaces, input/output elements, etc.

Buy side system 260 may be operable to acquire, store, and/or manage user registration information and preferences. For example, buy side system 260 may include a user registration and preferences server 261 operable to acquire, store, and/or manage user registration information and preferences. User registration and preferences server 261 may receive and store user information identifying one or more end users 222 that selected to participate in receiving customized electronic tasks.

User registration and preferences server 261 may receive user information from any suitable source in any suitable fashion. For example, user registration and preferences server 261 may receive user information from end users 222 engaging with host web site 281 during a user registration process, from one or more content managing entities 230, from one or more system managers 240, from an account associated with the end user 222 and hosted by a social networking web site 291, and/or from some other entity.

The user information may include unique identifiers associated with each end user 222 such as an alphanumeric user name, and may be associated with passwords such that only the end users 222 may login to electronic task system 210 and access information associated with their unique identifier. The user information may also or alternatively include demographic information concerning each end user 222. For example, user information may include one or more of age, gender, income level, race, location of residence, education level, marital status, ethnicity, etc.

User registration and preferences server 261 may also receive and store user preferences that indicate the preferences of end users 222. In some embodiments, the preferences may be set by the users themselves. For example, the users may indicate a preference to have notifications sent as short message service (SMS) messages. In other embodiments, the preferences may be set by entities other than end users 222, such as by system managers 240. For example, system managers 240 may set default preferences such as a maximum number of electronic tasks that may be received by a particular user in a day.

Buy side system 260 may be operable to perform order management operations. For example, buy side system 260 may include an order management server 262 operable to manage orders from content managing entities 230 for electronic tasks to be distributed to end users 222. Order management server 262 may receive and store conditions on which electronic tasks are to be distributed to end users 222. For example, a content managing entity 230 may input into order management server 262 conditions that, when satisfied, prevent the dissemination of one or more electronic tasks associated with the content managing entity 230.

The conditions that may prevent dissemination of electronic tasks may include one or more of a variety of conditions. For example, a condition may be satisfied when an electronic task has been communicated to a certain number of users. For another example, a condition may be satisfied when feedback information has been received from a certain number of users. For a further example, a condition may be satisfied when a certain amount of rewards have been issued for users' engagement with the electronic task. For yet another example, a condition may be satisfied by expiration of a certain time duration.

Buy side system 260 may be operable to perform reporting and analytics operations. For example, buy side system 260 may include a reporting and analytics server 263 operable to generate reports for content managing entities 230 or other entities and perform analytics on information concerning disseminated electronic tasks. Performing analytics may include acquiring and compiling various statistics concerning electronic tasks associated with a content managing entity 230. For example, for each electronic task associated with content managing entity 230, statistics such as the number of end users 222 which the electronic task has been communicated to, the number of end users 222 that have engaged in the electronic task, the number of end users 222 that have fully completed a required engagement with the electronic task, and an amount of rewards that have been issued to users for engaging in the task, may be generated. Any suitable statistical measure, such as average, mean, deviation, and the like, may be generated over any suitable time interval, such as hourly, daily, weekly, monthly, annually, and the like. Reporting may include compiling the results of the analytics and communicating those results to the content managing entities 230.

Buy side system 260 may be operable to perform billing operations. For example, buy side system 260 may include a billing server 264 operable to manage billing for the content managing entities 230. In managing billing, billing server 264 may receive a budget defined by the content managing entity 230 for rewards to be issued to end users 222. Receiving a budget may include receiving funds from the content managing entities. Billing server 264 may monitor an amount of resources spent on the electronic tasks associated with a content managing entity 230 (e.g., by issuance of rewards to end users 222 upon completion of their engagement with the electronic task). Billing server 264 may engage with payment partners 250 to perform a variety of billing-related functions, such as receiving funds from content managing entities 230,

Buy side system 260 may be operable to perform point or reward management operations. For example, buy side system 260 may include a points server 265 operable to manage rewards issued to end users 222 on behalf of content managing entities 230. In managing rewards, points server 265 may receive information from content managing entities 230 or other entities indicating a number and type of rewards to issue to end users 222 in the event end users 222 complete engagement with an electronic task. Points server 265 may then communicate rewards to the end users 222 in a variety of fashions. In one embodiment, points server 265 communicates with payment partners 250 to issue funds to accounts associated with end users 222.

Delivery system 270 may be operable manage delivery of electronic tasks to end users 222. Delivery system 270 may include any suitable components operable to perform the operations discussed herein with respect to delivery system 270, such as computer processors, storage elements, communication interfaces, input/output elements, etc.

Delivery system 270 may be operable to perform delivery service operations. For example, delivery system 270 may include a delivery service server 271 operable to perform delivery service operations. Delivery service server 271 may interact with other elements of system 200 so as to deliver electronic tasks to users over one or more mediums. For example, delivery service server 271 may interface with content distribution network (CDN) 292 so that copies of electronic tasks sourced by electronic task system 210 can be made available via CDN 292 and subsequently distributed to end user computing devices 220 associated with end users 222. For another example, delivery service server 271 may interface with a firewall 293(a) such that electronic tasks are communicated from delivery system 270 to end user computing devices 220 via firewall 293(a). In these cases, end users 222 may engage the electronic tasks via their mobile device 220. For yet another example, electronic tasks may be communicated from delivery system 270 to social networking web site 291 via firewall 293(a). In this case, end users 222 may engage the electronic tasks via social networking web site 291.

Delivery system 270 may be operable to perform optimization service operations, such as targeting, sequencing, and capping. For example, delivery system 270 may include an optimization service server 272 operable to perform delivery optimization operations.

Optimization service server 272 may perform various types of targeting, where electronic tasks are communicated only to select end users 222. For example, electronic tasks may be communicated only to end users 222 that selected to participate in receiving customized electronic tasks. In one embodiment, to determine which users have selected to participate in receiving customized electronic tasks, delivery system 270 may obtain user information from user registration and preferences server 261, such as the user information acquired during the user registration process. In another embodiment, to determine which users have selected to participate in receiving customized electronic tasks, delivery system 270 may detect execution of an end user application being executed by a particular end user 222. Targeting may also or alternatively include communicating electronic tasks to users based on demographic information associated with the users. The demographic information may be acquired from buy side system 260, and delivery system 270 may use the demographic information to communicate electronic tasks to select end users 222 satisfying one or more demographic criteria.

Optimization service server 272 may perform various types of sequencing, where electronic tasks are communicated in customized sequences. In one embodiment, where multiple electronic tasks are associated with a particular content managing entity 230, the distribution of those electronic tasks to end users 222 may be sequenced such that one electronic task is purposefully communicated only after a condition has been satisfied. For example, one electronic task may be communicated only after a previously communicated electronic task has been communicated, engaged by a user, completed by a user, etc.

Optimization service server 272 may perform various types of capping, where the number of electronic tasks communicated to end users 222 are capped. For example, the number of electronic tasks to be communicated may be limited based on the number of electronic tasks communicated to users, engaged by users, complete by users, etc. Information identifying the conditions on which communication of electronic tasks are to be capped may be received, for example, from order management server 262. Optimization service server 272 may then use this information to limit the number of electronic tasks communicated via delivery service server 271.

Electronic task system 210 may include a template database 282 operable to store templates of electronic tasks. The templates may be generated by any suitable entity, such as one or more system managers 240, and accessible to other entities, such as content managing entities 230, to edit. The templates may be templates by which entities such as content managing entities 230 may enter substantive data for electronic tasks. For example, a template may provide a framework in which a content managing entity 230 may upload images, video, or other content such as questions and answers, and may display the uploaded content to users in a format defined by the template. Template database 282 may be in communication with delivery system 270 so that customized electronic tasks incorporating one or more templates stored in template database 282 may be delivered to one or more users via delivery system 270. In one embodiment, template database 282 may be populated with templates from system managers 240.

Electronic task system 210 may include logs 283 where information concerning the operation of electronic task system 210 is recorded. For example, logs 283 may include information indicating which electronic tasks have been communicated to users, how many of each electronic task has been communicated to users, which users the electronic tasks have been communicated to, etc. Such information may be accessible by entities such as content managing entities 230 and system managers 240, where a pipeline 284 may be operable to communicate the information to content managing entities 230 via buy side system 260 and to system mangers 240 via a cubes and analytics server 286. The cubes and analytics server 285 may operate to perform analysis on the information of logs 283, where the analyzed information may then be communicated to entities such as content managing entities 240. For example, the information in logs 283 may be processed to identify users that have a high tendency to engage and/or complete electronic tasks communicated to them, and thereby provide recommendations to system managers 240 as to which users to further engage with electronic tasks.

System 200 in certain embodiments is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 2. Thus, the depiction of system 200 in FIG. 2 should be taken as being illustrative in nature, and not limiting to the scope of the disclosure.

In some embodiments, a server or system such as electronic task system 120 (FIG. 1) and/or electronic task system 210 (FIG. 2) may be operable to facilitate the sourcing electronic tasks. In sourcing tasks, the server or system provides the means by which parties may generate customized electronic tasks. To facilitate the generation of such tasks, the server or system may have software or hardware provided therein that is operable to provide an interface to entities, such as content managing entities, that have an interest in promoting a brand of goods or services. The content managing entity may then use the interface to create customized electronic tasks.

In creating customized electronic tasks, various techniques for creating tasks may be used. In one embodiment, templates may be stored by the server or system and accessed by the content managing entities. In some cases, the templates may be stored in electronic computing devices associated with the content managing entities. The content managing entity may then customize the template so as to generate a customized electronic task. In another embodiment, customized electronic tasks may be generated without the use of templates.

Once the server or system has generated or otherwise received customized electronic tasks, the system may identify users that wish to receive such tasks. Numerous techniques for such identification are discussed herein. In identifying users that wish to receive the tasks, the tasks can be communicated to only those users, thereby increasing the likelihood of user engagement with the task and reducing consumer discontent with receiving unrequested tasks.

The server or system may then communicate the task to the user, where the user may subsequently engage in the task in a variety of ways. The engagement may depend on the type of task communicated, such as whether the task is a question, a survey, a game, etc. Based on the user's level of engagement, the system may then award rewards to the user.

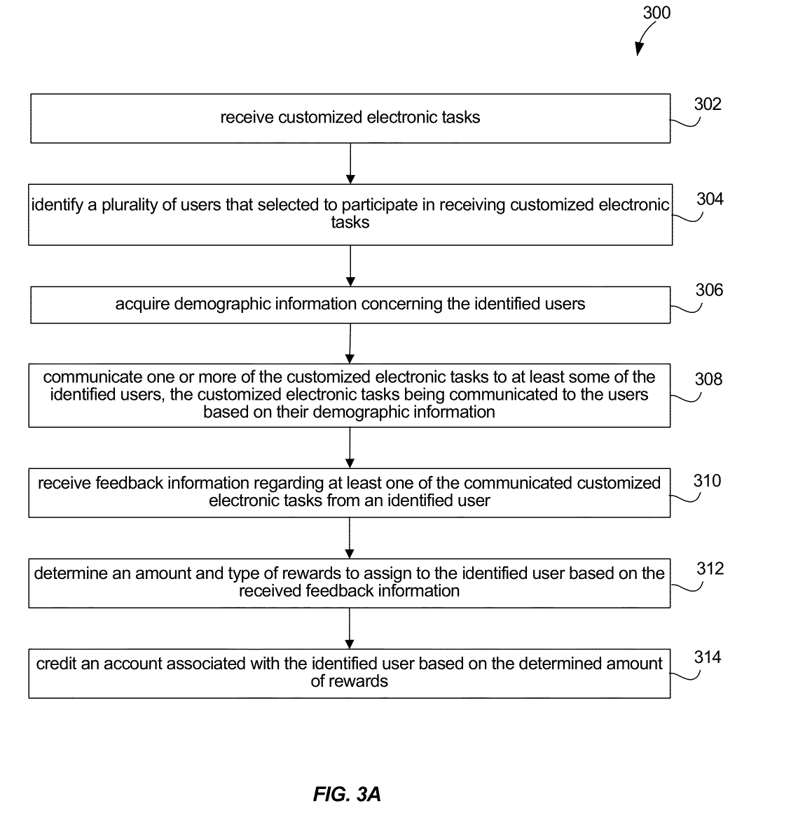

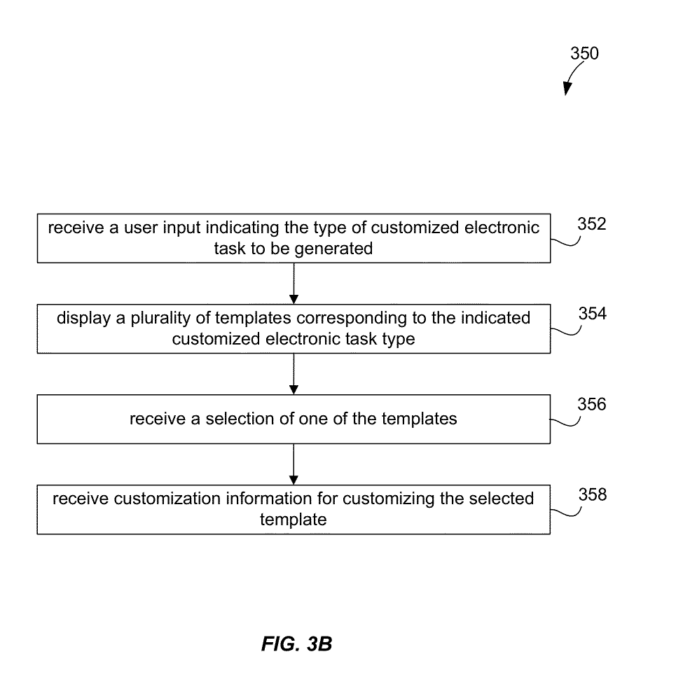

FIG. 3A is a flowchart depicting a method 300 of sourcing electronic tasks in accordance with at least one embodiment. The operations depicted and discussed with reference to method 300 may be performed by one or more elements of system 100 or system 200, or may be performed by one or more elements of systems not depicted herein. The operations may be performed by the same device or by different devices. In the following discussion, the operations depicted in method 300 are discussed as being performed solely by electronic task system 120 (FIG. 1) and/or by electronic task system 210 (FIG. 2) (hereinafter referred to as “electronic task system 120/210”). However, embodiments of the invention are not so limited as some as all of the operations depicted in method 300 may be performed by servers, systems, devices, or entities other than electronic task system 120/210.

In operation 302, electronic task system 120/210 receives customized electronic tasks, where each electronic task. In some embodiments, the task may be to acquire information from an end user. In other embodiments, the task may be customized to promote a brand of goods or services. The tasks are interactive in that they require engagement by a user, such as end user 222. The type of engagement required depends on the type of electronic task. Embodiments include various types of electronic tasks, such as questions, surveys, actions, and/or games.

A question type of electronic task poses a question to the user. The question may be any question, where the content of the question is input by an entity other than the end user (e.g., by a content managing entity 230) and the content of the answer is provided by the user (e.g., end user 222). The question may solicit various types of information relevant to a particular content managing entity, such as user opinions, user preferences, translation of words or phrases from one language to another, identification of objects, review of content accuracy, etc. For example, a content managing entity of a coffee company may ask the question “Which kind of coffee do you like?”. The type of engagement in these cases is a response to the question.

A survey type of electronic task presents a survey to the user. In presenting a survey, a number of questions are typically presented to the user, as are a number of possible answer choices for each question. However, a survey may include open-ended questions, and may include only one question. Like questions, the survey may solicit various types of information relevant to a particular content managing entity. For example, a content managing entity of a coffee company may ask the question “Which of the following coffees is your favorite?” and list a selection of coffee brands. The type of engagement in these cases is the survey results, which indicate the user's selection of answer choices for the various questions.

An action type of electronic task presents an action which the user must perform in order to engage the task. The action may be any action deemed desirable by the content managing entity and which a recordation indicating the execution thereof can be communicated to the electronic task system 120/210. For example, the action may be for the user to visit a webpage, download a software program, execute a software program, and/or the like. Upon the user performing the action, the electronic task system 120/210 may be notified of the user's completion of the action. In some cases, the electronic task system 120/210 may be notified of a user's partial completion of an action, or completion of multiple actions. The type of engagement in these cases is execution of the action.

An action type of a game task presents a game which the user may play to engage the task. The game may be any suitable game that the content managing entity deems useful for promoting a brand of goods or services. For example, a promoter of a car racing event may provide a game in which a user must race a car around a track in less than thirty seconds. For another example, a promoter of a soft drink company may provide a game in which a user must race a car covered with trademarks of the soft drink company around a track in less than thirty seconds. The type of engagement in these cases is participation in the game.

The electronic tasks are customized in that an entity such as content managing entity 230 may provide the content of the tasks, where the content is generated to promote a brand of goods or services. In some embodiments, a template of the tasks may be provided to content managing entity 230 from electronic task system 120/210 for customization, as further discussed with reference to FIG. 3B. In other embodiments, the task may be generated without the assistance of a template. For example, with respect to game-type electronic tasks, the game may be a full production game, in that content managing entity 230 may provide all of the source code for the game.

The customized electronic tasks may be received from one or more sources. In one embodiment, a template may first be generated and stored in electronic task system 120/210, for example in template database 282. The template may be generated by any suitable entity. For example, the template may be generated by a system manager 240. The template may then be customized, as discussed with reference to FIG. 3B, by receiving customization information from, for example, a content managing entity 230. With reference to FIG. 1, the template may be entered and customized by entities associated with one or more content manager computing devices 130(a)-130(n). In another embodiment, the customized electronic tasks may be received without the use of a template. For example, the customized electronic tasks may be communicated in their entirety from an entity such as a content managing entity 230.

In operation 304, a plurality of users that selected to participate in receiving customized electronic tasks are identified. By identifying the users that selected to participate in receiving customized electronic tasks, electronic task system 120/210 may discriminate between these users and other users that did not select to participate in receiving customized electronic tasks. By making such a discrimination, customized electronic tasks may be selectively communicated to the users that selected to participate without communicating the tasks that did not select to participate. In other words, the customized electronic tasks may be communicated only to those users that opt in to receive such tasks.

Numerous techniques for identifying users that select to participate in receiving customized electronic tasks may be used. In one embodiment, users may register to receive customized electronic tasks. For example, a user may submit user information to electronic task system 120/210, for example to user registration and preferences server 261. The user information may be communicated to and stored by electronic task system 120/210 in any suitable fashion, such as via a web page hosted by host web site 281, via a social networking web site 291, and/or via an end user computing device 220.

In another embodiment, electronic task system 120/210 may detect execution of an application, whereby execution of the application indicates a user's selection to participate in receiving customized electronic tasks. For example, a user may download an application to execute on an end user computing device 110(a) (FIG. 1) or end user computing device 220 (FIG. 2) (hereinafter referred to as “end user computing device 110(a)/220”). Upon execution of the application, the application may cause end user computing device 110(a)/220 to communicate the identity of end user computing device 110(a)/220 and, in some cases a user associated with end user computing device 110(a)/220, to electronic task system 120/210. Electronic task system 120/210 may then store the identity of end user computing device 110(a)/220 or the user associated with end user computing device 110(a)/220 for subsequently communicating customized electronic tasks to the device or user. For another example, a user may execute an application stored on a server or servers remote from the user (such as on social networking web site 291), where the application is associated with the user (such as a user account established on social networking web site 291). Upon execution of the application, the user's identity may be communicated to electronic task system 120/210 for subsequent reception of customized electronic tasks.

In operation 306, demographic information concerning the identified users is acquired. Electronic task system 120/210 may acquire demographic information using one or more suitable techniques for acquiring demographic information. For example, a user may communicate demographic information to electronic task system 120/210 during the registration process. For another example, electronic task system 120/210 may receive demographic information from one or more entities at which the user has already submitted demographic information, such as from an account associated with the user and held by social networking web site 291. For yet another example, electronic task system 120/210 may acquire demographic information from one or more third party entities, such as address directories, government entities, private entities that operate to accumulate and sell such information, and the like.

In operation 308, one or more of the customized electronic tasks are communicated to at least some of the identified users. In one embodiment, the customized electronic tasks are communicated to a subset of the identified users based on demographic information of the users. For example, a task may concern a high-priced automobile and be communicated only to users having an annual income greater than a threshold amount. In another embodiment, the customized electronic tasks may be communicated to all of the identified users. In other embodiments, the customized electronic tasks may be communicated to one or more users based on criteria other than user demographics. For example, tasks may be communicated to users having a user name starting with a particular alphanumeric character.

The customized electronic tasks may be communicated to the users in one or more of a variety of fashions. With reference to FIG. 1, the tasks may be communicated from electronic task system 120 to an end user computing device 110(a) associated with an identified user via network 150 for display on I/O element 118. With reference to FIG. 2, in one embodiment, the tasks may be communicated from delivery system 270 to an end user computing device 220 associated with end user 222 via CDN 292 or via firewall 293(a). In another embodiment, the tasks may be communicated from delivery system 270 to an account associated with end user 222 held by social networking web site 291 via firewall 293(a). In yet another embodiment, the tasks may be communicated from delivery system 270 to host web site 281 which is accessible to end user 222 via firewall 293(b).

In operation 310, feedback information regarding at least one of the communicated customized electronic tasks is received from an identified user. The feedback information is indicative of a level of engagement with the communicated task by the user. The feedback information may indicate various levels of engagement, such as a completed engagement, a partial engagement, or no engagement. The feedback information may be generated by any suitable entity. For example, the feedback information may be generated by one or more of end user computing device 110/220, social networking web site 291, and host web site 281. In some embodiments, the feedback information may be generated by an application executing on an entity which also operates to communicate customized electronic tasks to the end user.

In operation 312, an amount and type of rewards to assign to the identified user is determined based on the received feedback information. A variety of different types of rewards may be assigned to the identified user. For example, rewards may include points, credits, badges, coupons, sweepstakes entries, loyalty cards, etc. In some embodiments, rewards may be issued and associated with different entities. Rewards may be issued by a content managing entity 230 associated with a task that the user has engaged in. For example, credits may be acquired for redemption of physical goods or services provided by content managing entity 230, coupons may be acquired offering discounts to products or services provided by content managing entity 230, and sweepstake entries may be acquired providing an entry into a sweepstakes organized by content managing entity 230. Rewards may additionally (e.g., simultaneously) or alternatively be issued by a system manager 240, in which case the rewards may be common to all content managing entities 230. For example, credits may be acquired for redemption of monetary value such as a prepaid credit card by system manager 240, and sweepstake entries may be acquired providing an entry into a sweepstakes organized by system manager 240.

Different amounts of rewards may be assigned to the identified user based on the received feedback information. In some embodiments, an amount of award may be commensurate with an amount of engagement of the task by the user. For example, a large award may be assigned for a high level of engagement, and a small award may be assigned for a low level of engagement. In other embodiments, an amount of award may be fixed, such that an amount of award is assigned as long as the user satisfies some bare minimum level of engagement.

In some embodiments, each user may be provided with a level, typically beginning with level 1. The users may then increase their level to level 2, level 3, and the like, by engaging in tasks. By engaging in more tasks, the users level may continue to increase. Levels may also or alternatively be increased based on other factors, such as how long the user has been registered to receive tasks, the number of tasks received by the user, etc. As a result of increasing in level, the user may receive increased benefits. For example, at higher levels, the user may receive a higher amount of rewards for engaging a particular task compared to the amount of rewards received for engaging the task at a lower level. For another example, at higher levels, the user may receive different tasks compared to users at lower levels. Level information indicating a user's current level may be stored in electronic task system 120/210.

In some embodiments, different types of levels may be provided. For example, one sequence of levels may be provided by a particular content managing entity 230, where the sequence of levels increases only upon a users engagement with tasks provided by that particular content managing entity 230. For another example, a separate or additional sequence of levels may be provided where the sequence of levels increases upon a users engagement with tasks provided by a subset of content managing entities 230. For yet another example, a separate or additional sequence of levels may be provided where the sequence of levels increases upon a users engagement with tasks provided by any content managing entity 230.

In operation 314, an account associated with the identified user is credited based on the determined amount of rewards. An account for each user may be stored by electronic task system 120/210, where the account includes user information, demographic information, and other relevant information for the user. The account may also include an indication as to the type and amount of rewards earned by the user, minus any disbursements of rewards.

FIG. 3B is a flowchart depicting a method 350 of receiving customized electronic tasks in accordance with at least one embodiment. The operations depicted and discussed with reference to method 350 may be performed by one or more elements of system 100 or system 200, or may be performed by one or more elements of systems not depicted herein. The operations may be performed by the same device or by different devices. In the following discussion, the operations depicted in method 350 are discussed as being performed solely by electronic task system 120/210. However, embodiments of the invention are not so limited some or all of the operations depicted in method 350 may be performed by servers, systems, devices, or entities other than electronic task system 120/210.

In operation 352, a user input indicating the type of electronic task to be generated is received. The user input may be received by electronic task system 120/210 from any entity interested in generating a customized electronic task. For example, the user input may be received from a content managing entity 230 via an electronic computing device associated with the content managing entity 230. The user input may indicate any of the types of electronic tasks already discussed, such as questions, surveys, actions, and games.

In operation 354, a plurality of templates corresponding to the indicated electronic task type is displayed. The templates may be stored by electronic task system 120/210 (for example, in template database 282) and communicated to the electronic computing device associated with the content managing entity 230 for display to the content managing entity 230. The templates may be communicated, for example, via firewall 293(c).

In operation 356, a selection of one of the templates is received. Similar to operation 352, the selection may be received from an electronic computing device associated with the content managing entity 230. Upon selection of a particular template, the selected template may then subsequently be customized.

In operation 358, customization information for customizing the selected template may be received. Similar to operation 352, the customization information may be received from an electronic computing device associated with the content managing entity 230. Upon receiving the customization information, the customized template may then be used as a customized electronic task.

It should be appreciated that the specific operations illustrated in FIGS. 3A to 3B provide particular methods of sourcing electronic tasks, according to certain embodiments of the present invention. Other sequences of operations may also be performed according to alternative embodiments. Moreover, the individual operations illustrated in FIGS. 3A to 3B may include multiple sub-operations that may be performed in various sequences as appropriate to the individual operation. Furthermore, additional operations may be added or existing operations removed depending on the particular applications. Accordingly, one of ordinary skill in the art would recognize and appreciate many variations, modifications, and alternatives.

In some embodiments, a user may consume the customized electronic tasks that are generated and communicated to the user via the electronic task server or system. Consuming tasks may include the user providing some sort of identification to a remote server or system (e.g., a social networking service), or may execute an application that inherently identifies the user or a computing device associated with the user. The identity of the user or user device may then be communicated to the electronic task server or system so that the electronic task server or system recognizes a destination which to communicate customized tasks to. The user may then receive one or more customized tasks which the user may then selectively choose to engage. As a result of the user's engagement, feedback information indicating the user's level of engagement may be communicated back to the electronic task server or system so that the electronic task server or system recognizes the user's level of engagement and can consequently provide rewards to the user commensurate with the user's level of engagement.

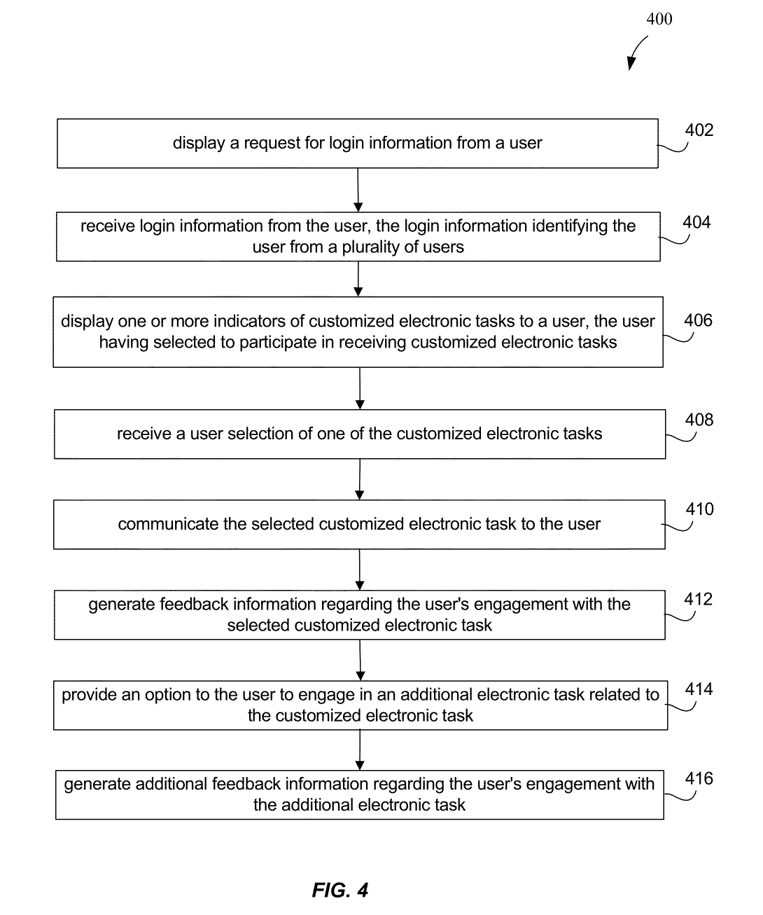

FIG. 4 is a flowchart depicting a method 400 of consuming customized electronic tasks in accordance with at least one embodiment. The operations depicted and discussed with reference to method 400 may be performed by one or more elements of system 100 or system 200, or may be performed by one or more elements of systems not depicted herein. The operations may be performed by the same device or by different devices. In the following discussion, the operations depicted in method 400 are discussed as being performed solely by end user computing device 110(a)/220. However, embodiments of the invention are not so limited some as all of the operations depicted in method 300 may be performed by servers, systems, devices, or entities other than end user computing device 110(a)/220. For example, the operations depicted in method 400 may be performed in part or entirely by social networking web site 291 or host web site 281.

In operation 402, a request for login information from a user is displayed. Login information may include any suitable information for identifying and authenticating a user. For example, login information may include a user identifier such as a user name as well as authenticating information such as a password. The request may be displayed on an end user computing device 220 associated with end user 222.

In operation 404, login information is received from the user, the login information identifying the user from a plurality of users. The login information may be entered by end user 222 into end user computing device 220 and received by end user computing device 220. In identifying the user, the login information may be compared with stored user information. For example, electronic task system 120/210 may store user information of registered users, may receive the login information from end user computing device 220, and compare the received login information with stored user information to determine whether the user is registered. If it is determined that the user is registered, electronic task system 120/210 may then communicate one or more customized electronic tasks to the end user computing device 220 for display to and engagement by end user 222.

In operation 406, one or more indicators of customized electronic tasks are displayed to the user, the user having selected to participate in receiving customized electronic tasks. The indicators may be displayed via, for example, a display element of end user computing device 220, where the indicators may be displayed only if the user selected to participate in receiving customized electronic tasks. In some embodiments, the indicators may be displayed only if the user selected to participate in receiving customized electronic tasks and the user has been targeted to receive particular customized electronic tasks.

In operation 408, a user selection of one of the customized electronic tasks is received. End user 222 may select one of the customized electronic tasks displayed on end user computing device 220 using, for example, an input element of end user computing device 220. The user may select a task which the user wishes to engage in.

In operation 410, the selected customized electronic task is communicated to the user. The task may be communicated to end user 222 via an output element of end user computing device 220. In response to communicating the task to the user, the user may engage the task in a variety of fashions as previously discussed. The response may include the user entering information into end user computing device 220, playing a game on end user computing device 220, using end user computing device 220 or another electronic computing device to perform some action, etc.

In operation 412, feedback information is generated regarding the user's engagement with the selected customized electronic task. The feedback information is indicative of a level of engagement with the communicated task by the user. In one embodiment, the feedback information may be generated by end user computing device 220. For example, the feedback information may be content entered by the user into end user computing device 220 and subsequently converted by end user computing device 220 for communication to electronic task system 120/210. For another example, end user computing device 220 may process the information received by the user to determine a level of engagement, and subsequently communicate the level of engagement to electronic task system 120/210.

In operation 414, an option is provided to the user to engage in an additional electronic task related to the customized electronic task. For example, once the user completes their engagement with a customized electronic task, an option may be provided allowing the user to engage in an additional task. The additional electronic task may be similar to or different than the original electronic task.

In operation 416, additional feedback information is generated regarding the user's engagement with the additional electronic task. The additional feedback information may be similar to that discussed with reference to operation 412, however in this case directed to a user's level of engagement with the additional electronic task rather than the original electronic task.

It should be appreciated that the specific operations illustrated in FIG. 4 provides a particular method of consuming customized electronic tasks, according to certain embodiments of the present invention. Other sequences of operations may also be performed according to alternative embodiments. Moreover, the individual operations illustrated in FIG. 4 may include multiple sub-operations that may be performed in various sequences as appropriate to the individual operation. Furthermore, additional operations may be added or existing operations removed depending on the particular applications. Accordingly, one of ordinary skill in the art would recognize and appreciate many variations, modifications, and alternatives.

In some embodiments, a server or system such as electronic task system 120 (FIG. 1) and/or electronic task system 210 (FIG. 2) may facilitate the sourcing electronic tasks by providing a graphical user interface to parties that wish to generate customized electronic tasks, such as content managing entities. The user interface may take any suitable form, and may be populated by data provided by the electronic task server or system. Via the interface, the content managing entity may select to create a new electronic task, in some cases using a template as a basis of the task. After choosing the type of task to create, such as a question, survey, action, or game, the content managing entity may select an appropriate template. Following template selection, the content managing entity may customize the template by providing content to the template, such as text, images, and the like. In some cases, previews of the task may be displayed to the content managing entity so that the content managing entity can quickly identify what the customized task will appear like to an end user.

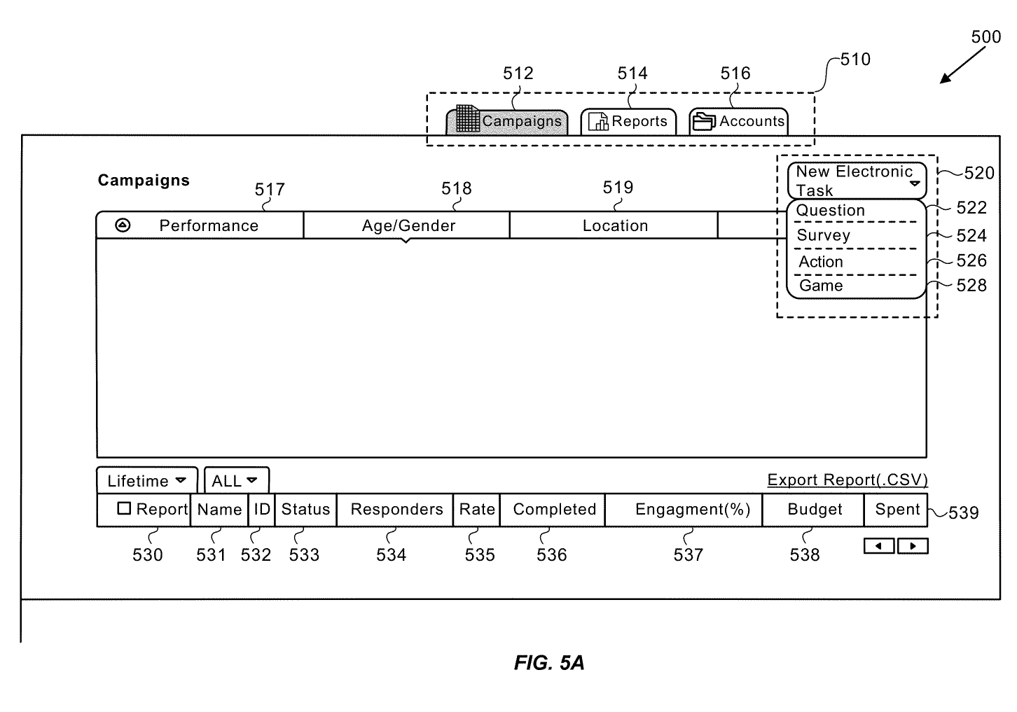

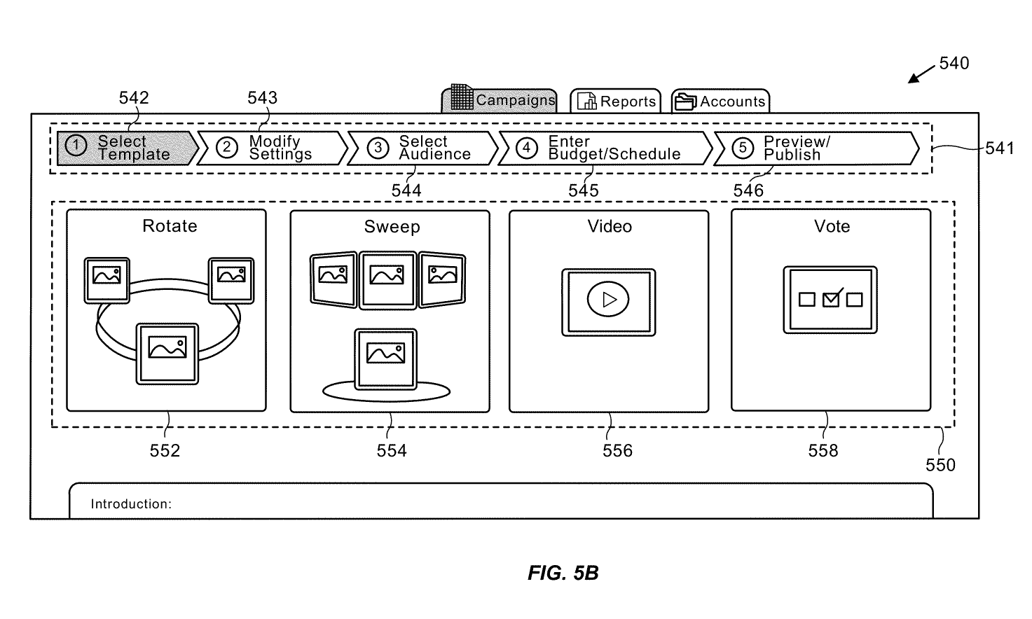

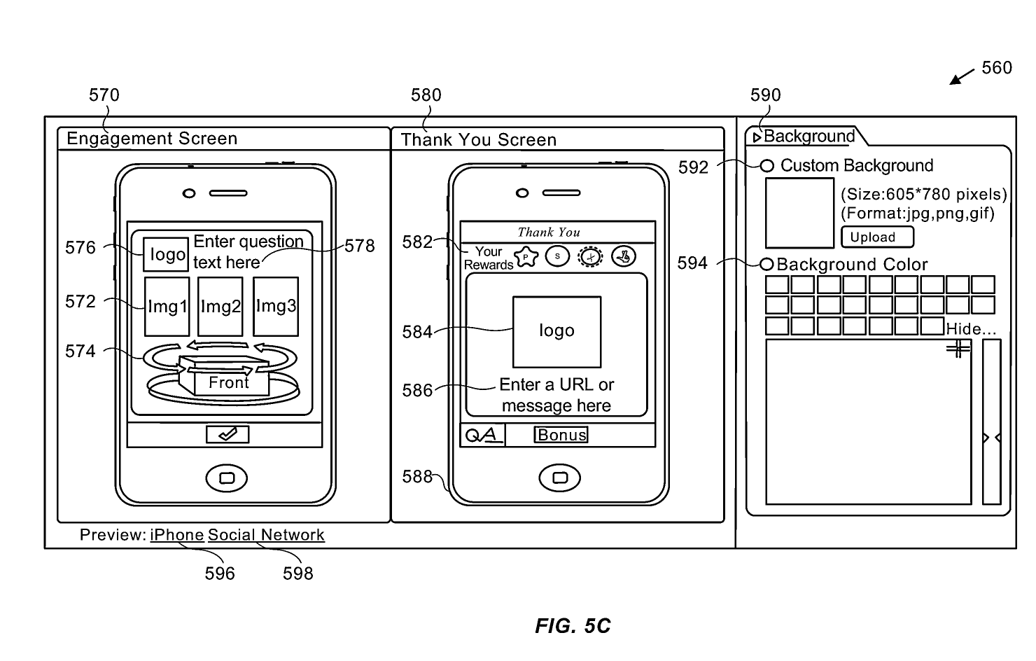

FIG. 5A illustrates a computer generated interface 500 for selecting a type of electronic task to be generated in accordance with at least one embodiment. The interfaces depicted and discussed with reference to FIGS. 5A to 5C may be generated by one or more elements of system 100 or system 200, or may be generated by one or more elements of systems not depicted herein. In the following discussion, the interfaces are discussed as being generated by electronic task system 120/210 (FIGS. 1 and 2) for display to and input from content manager computing device 130(a) (FIG. 1) and/or content managing entities 230 (FIG. 2). However, embodiments of the invention are not so limited some as all of the elements of the interfaces may be generated by servers, systems, devices, or entities other than electronic task system 120/210.

Computer generated interface 500 may include options for allowing content managing entities 230 to manage various aspects of electronic tasks. Interface 500 may be generated by electronic task system 120/210 for display to a brand manager 230. For example, components of interface 500 may be hosted on a web server such as host web site 281 or buy side system 260 and remotely viewed or otherwise accessed by content managing entities 230 using electronic computing devices associated with content managing entities 230. Interface 500 may be displayed on a display element of electronic computing devices associated with content managing entities 230 (e.g., I/O element 138), and content managing entities 230 may provide inputs into interface 500 via an input element of the electronic computing devices associated with content managing entities 230 (e.g., I/O element 138).

In one embodiment, interface 500 includes selectable options 510. Selectable options 510 include a campaigns tab 512, a reports tab 514, and an accounts tab 516. Options 510 are shown as tabs, but embodiments of the invention are not so limited, as options 510 may be provided as any selectable input element such as a hyperlink, drop-down menu, radio button, etc.

Upon selection of campaigns tab 512, various information regarding advertising campaigns may be generated and displayed. For example, for each advertising campaign, a summary of the performance 517 of the campaign, an age/gender 518 of users at which the campaign is directed, and/or a geographical location 519 at which the advertising campaign is directed may be displayed. In one embodiment, an option 520 to generate a new electronic task may be provided. Selection of option 520 may allow a user to select a new question-type task 522, survey-type task 524, action-type task 526, and/or game-type task 528 to be generated. By user selection of one of the options 520, a user may proceed to generate a customized electronic task.

Other types of information may be available via selection of campaigns tab 512 as well. For example, reports for campaigns may be generated, viewed, exported, and the like, via selection of a report element 530. Information generated for a report may include a name 531 of an advertising campaign, an identifier 532 for identifying a campaign, a status 533 of the campaign (e.g., not begun, in process, completed), the number of responders 534 or end users that engaged in tasks distributed as part of the campaign, the rate 535 at which users responded to the tasks communicated to them as part of the campaign, the number of users that completed 536 the required engagement of tasks distributed as part of the campaign, the percentage of users that engaged 537 in the tasks, the budget 538 of the campaign, and the amount of money spent 539 on the campaign.

FIG. 5B illustrates a computer generated interface 540 for selecting a template to be used in generating a customized electronic task in accordance with at least one embodiment. Computer generated interface 540 may include options for allowing content managing entities 230 to generate an advertising campaign. Similar to computer generated interface 500, computer generated interface 540 may be generated by electronic task system 120/210 for display to a content managing entity 230. In some embodiments, computer generated interface 540 may be generated and displayed to content managing entity 230 as a result of option 520 (FIG. 5A) being selected.

In one embodiment, computer generated interface 540 may guide the user through a sequence of events 541. The sequence of events 541 may include options for the user to select a template 542, modify settings 543 or otherwise customize the selected template, select an audience 544 to which customized electronic tasks are to be distributed, enter a budget/schedule 545 for defining order management requirements, and preview/publish 546 the generated customized electronic task.

As part of the event in which a template is selected, a plurality of templates 550 may be displayed. Templates 550 may be communicated from, for example, template database 282. The templates 550 displayed may correspond to the type of electronic task chosen. For example, in the embodiment illustrated in FIG. 5B, templates 550 are displayed in accordance with selection of a survey-type task 524. The templates may provide any suitable framework in which an entity such as content managing entity 230 may add content.

In the embodiment shown in FIG. 5B, four templates are shown, including an image rotate template 552, an image sweep template 554, a video template 556, and a voting template 558. Rotate template 552 may be a template in which images can be selectively rotated about an axis perpendicular to the screen surface, whereby one of the images may be enlarged at the forefront of the screen. Each image may display any suitable information for performing a survey. For example, each image may provide a unique answer to a survey question. Sweep template 554 may be a template in which images can be selectively rotated about an axis parallel to the screen surface, whereby one of the images may be duplicated and enlarged at the forefront of the screen. Each image may display any suitable information for performing a survey. Video template 556 may be a template in which a video can be displayed to an end user. The video may display any suitable information for performing a survey. For example, the video may present a survey question and unique answers to the question. Voting template 558 may be a template in which a survey question and/or answers are presented to the user in a single screen. The survey question and/or answers may be presented in any suitable format, such as providing check boxes, radio buttons, etc. for user selection of an answer.

FIG. 5C illustrates a computer generated interface 560 for providing customization information to be used in generating a customized electronic task in accordance with at least one embodiment. Upon user selection of one of templates 550, computer generated interface 560 may present the content managing entity 230 with an opportunity to provide customization information for customizing the selected template, which may include modifying one or more settings associated with the selected template.

Computer-generated interface 560 may include an engagement screen 570 in which content managing entity 230 may customize the selected template. For example, computer generated interface 560 may allow a content managing entity 230 to upload images and/or video to be used in the selected template, allow the content managing entity 230 to enter text concerning the questions to be asked to end users 222, allow the content managing entity 230 to enter text concerning one or more answers to the questions to be asked to end users 222, etc.

In the embodiment shown in FIG. 5C, content managing entity 230 may have selected a sweep template. Content managing entity 230 may then upload images 572 to be presented to an end user 222, and show the content managing entity 230 the sequence of rotation 574 for the image sweep. Engagement screen 570 may also allow content managing entity 230 to upload a logo 576 such as a company logo or brand image, and allow content managing entity 230 to enter a question 578 to be displayed in conjunction with the images 572.

Computer-generated interface 560 may also include a thank you screen 580 in which content managing entity 230 may customize a thank you screen template to be communicated subsequent to a user completing their engagement with the customized electronic task. The thank you screen template may be generic to the different types of advertising templates available, or may be unique to some or all of the advertising templates. In the embodiment shown in FIG. 5C, the thank you screen template may provide options to customize the amount and type of rewards 582 issued in response to the user completing their engagement with the task, upload a logo 584 such as a company logo or brand image, enter a URL or message 586, and/or provide a link 588 enabling the end user to engage in an additional electronic task.

Computer-generated interface 560 may also include one or more customization screens 590 in which further aspects of the selected template may be customized. For example, as shown in FIG. 5C, a screen for customizing a background may be displayed. An option to generate a custom background 592 may be provided, in which a content managing entity 230 may upload an image to be used as a background. Additionally or alternatively, an option to choose a background color 594 may be provided, in which a content managing entity 230 may choose one of a plurality of colors to be used as a background. Customization screen 590 may be displayed upon user selection of a customization option available for any suitable screen, such as engagement screen 570 and/or thank you screen 580. For example, the background color surrounding images 572 may be customized via customization screen 590.

In some embodiments, computer generated interface 560, while allowing customization information to be provided, may display the selected template and customization information in a predefined format. For example, by selecting preview option 596, the selected template and customization information may be shown to content managing entity 230 in the format as they would be presented to an end user via a mobile device such as an iPhone™. For another example, by selecting preview option 598, the selected template and customization information may be shown to content managing entity 230 in the format as they would be presented to an end user via a social networking service such as Facebook™.

It should be appreciated that the specific graphical interfaces illustrated in FIGS. 5A to 5C provide graphical interfaces for sourcing electronic tasks, according to certain embodiments of the present invention. Other graphical interfaces, elements of graphical interfaces, arrangements of information on graphical interfaces, and the like may also be used according to alternative embodiments. Moreover, graphical interface elements may be added or existing shown graphical interface elements removed depending on the particular applications. Accordingly, one of ordinary skill in the art would recognize and appreciate many variations, modifications, and alternatives.

In some embodiments, a server or system such as electronic task system 120 (FIG. 1) and/or electronic task system 210 (FIG. 2) may facilitate conduct related to the creation of electronic tasks, such as billing, reward creation, reward funding, etc. In facilitating such conduct, the server or system may communicate with financial entities such as credit card companies, banking institutions, and the like via payment gateways or the like. The server or system may thus be operable to receive funds from entities such as content managing entities, distribute funds to entities such as end users, maintain records of such transactions, and provide records of such transactions to the various entities.

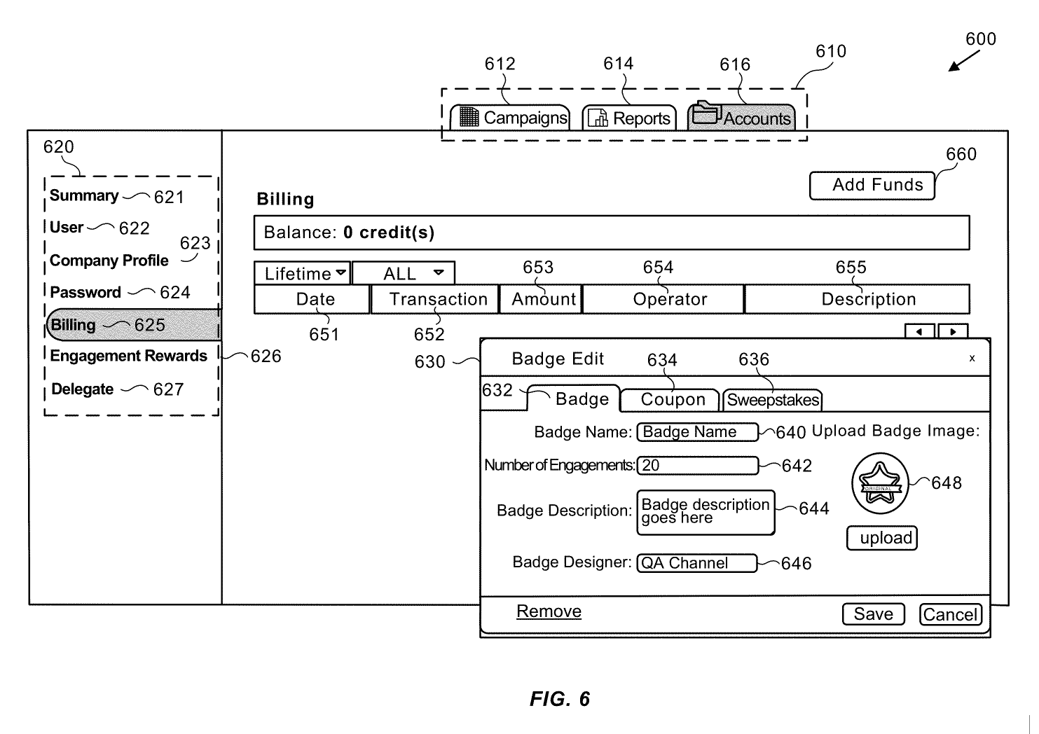

FIG. 6 illustrates a computer generated interface 600 for creating rewards to be disbursed to users in accordance with at least one embodiment. The interface depicted and discussed with reference to FIG. 6 may be generated by one or more elements of system 100 or system 200, or may be generated by one or more elements of systems not depicted herein. In the following discussion, the interface is discussed as being generated by electronic task system 120/210 (FIGS. 1 and 2) for display to and input from content manager computing device 130(a) (FIG. 1) and/or content managing entities 230 (FIG. 2). However, embodiments of the invention are not so limited some as all of the elements of the interface may be generated by servers, systems, devices, or entities other than electronic task system 120/210.

Computer generated interface 600, similar to computer generated interface 500 discussed with reference to FIG. 5A, may include options for allowing content managing entities 230 to manage various aspects of electronic tasks. Similar to selectable options 510 (FIG. 5A), computer generated interface 600 may also provide selectable options 610 including campaigns tab 612, reports tab 614, and accounts tab 616. In this case, accounts tab 616 may have been selected, resulting in various information regarding a content managing entities 230 account being displayed.

Entities such as content managing entities 230 may each have an account stored and managed by electronic task system 120/210. Information regarding the account, such as information identifying the account holder, may be stored and maintained by electronic task system 120/210. By logging in and selecting the accounts tab 616, a content managing entity 230 may view and edit various elements of their account. For example, a content managing entity 230 may select an option 620 to view various account-related information, such as a summary 621 of their account, information identifying a user 622 such as a content managing entity 230 associated with the account, information describing a company profile 623 associated with the account, information concerning a password 624 associated with the account, billing information 625, information concerning rewards 626, and information concerning delegates 627 to which responsibilities such as account management, campaign management, and/or reporting may be delegated.

Upon selection of the billing option 625, various information regarding a budget of the account may be displayed. For example, a window 630 may be provided in which content managing entity 230 may enter rewards for distribution to end users 222 upon engagement of electronic tasks. Various types of rewards as previously discussed may be defined. In the embodiment shown in FIG. 6, badges 632, coupons 634, and sweepstake entries 636 may be defined. For example, in defining a badge, upon selection of the badge tab 632, content managing entity 230 may input relevant information for defining a badge, such as a badge name 640, a number of engagements 642 with tasks disseminated by content managing entity 230 necessary to earn the badge, a badge description 644, and a badge designer 646. An option may also be available to upload an image 648 of the badge, or content managing entity 230 may select a badge from a predefined selection of badges.

Other types of information may be available via selection of billing option 625 as well. For example, transactions with entities such as system managers 240 may be shown. In some embodiments, funds or other types of value may be transferred from content managing entities to system managers 240. For example, for each customized electronic task communicated to an end user 222, funds may be transferred from a content managing entity associated with the task to system managers 240. Various information concerning the transactions between such entities may be provided, such as a date 651 on which a transaction was performed, a transaction identifier 652 associated with the transaction, an amount 653 of value of the transaction, an operator 654 identifying an entity from which the funds were transferred, and a description 655 of the transaction. In some embodiments, an add funds option 660 may also be provided, selection of which allows content managing entities 230 to transfer funds to their account.

It should be appreciated that the specific graphical interface illustrated in FIG. 6 provides a graphical interface for sourcing electronic tasks, according to certain embodiments of the present invention. Other graphical interfaces, elements of graphical interfaces, arrangements of information on graphical interfaces, and the like may also be used according to alternative embodiments. Moreover, graphical interface elements may be added or existing shown graphical interface elements removed depending on the particular applications. Accordingly, one of ordinary skill in the art would recognize and appreciate many variations, modifications, and alternatives.

In some embodiments, a user may engage with the electronic task server or system via a social networking service, such a Facebook™. Such engagement may result from the user selecting an application, which is operable to interface and communicate with the electronic task server or system, to install and integrate with the social networking service. The user may then access the functionality of the application via the social networking service. The application may provide the user with a graphical interface via which the user may receive customized electronic tasks destined for the user, and engage with those tasks. The graphical interface may also provide the user with other options related to the provision of electronic tasks, such as a user profile, reward information, statistics regarding the user's account, and the like.

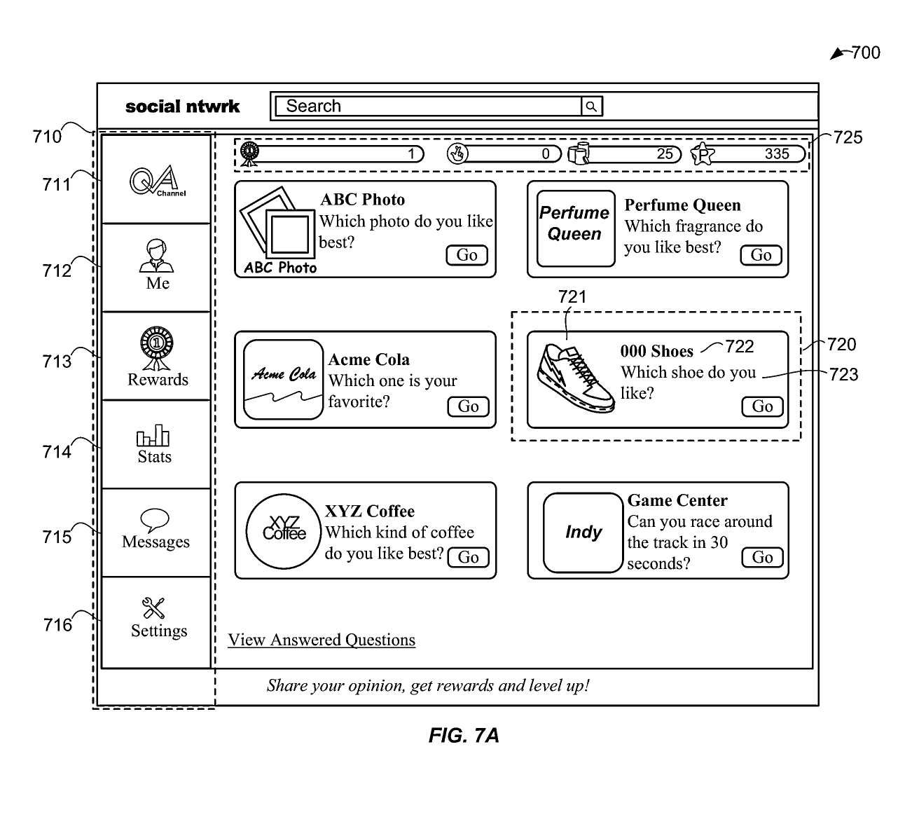

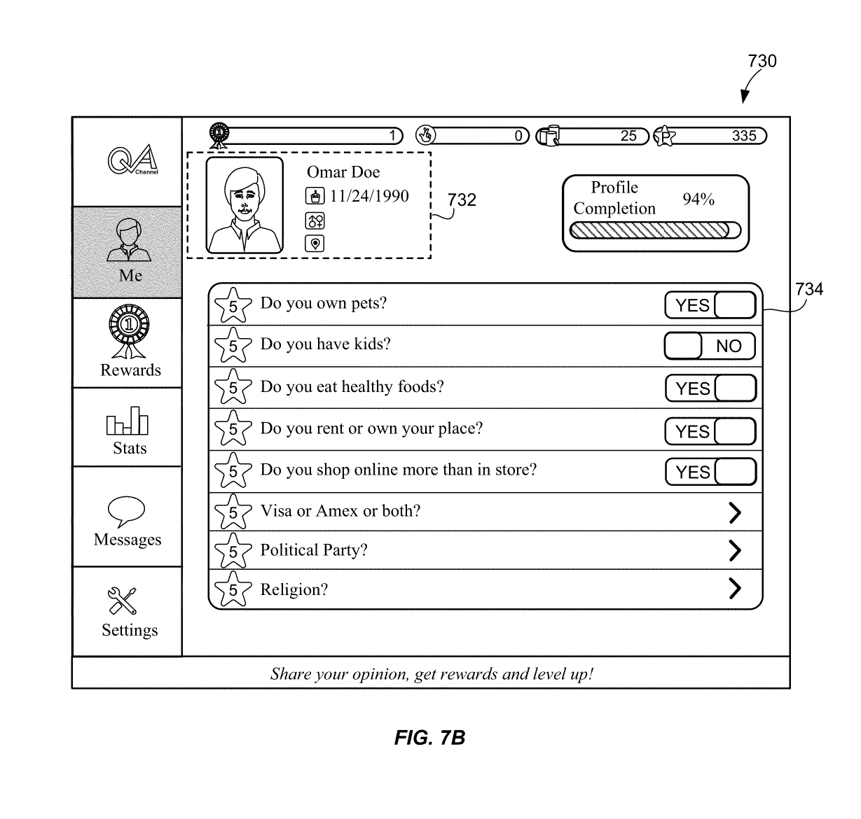

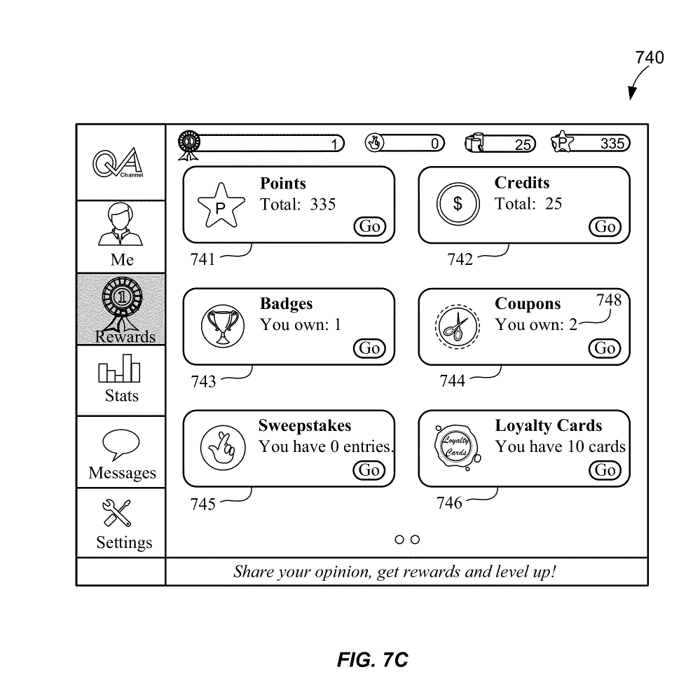

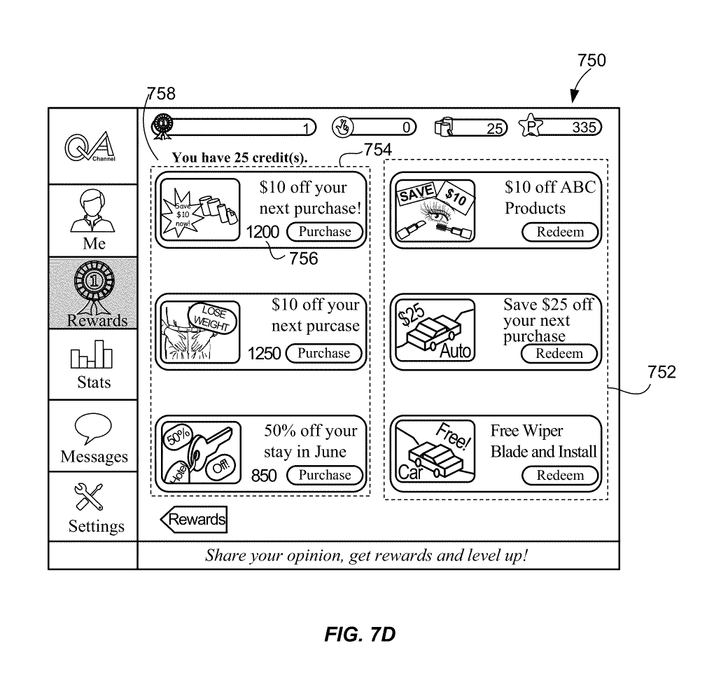

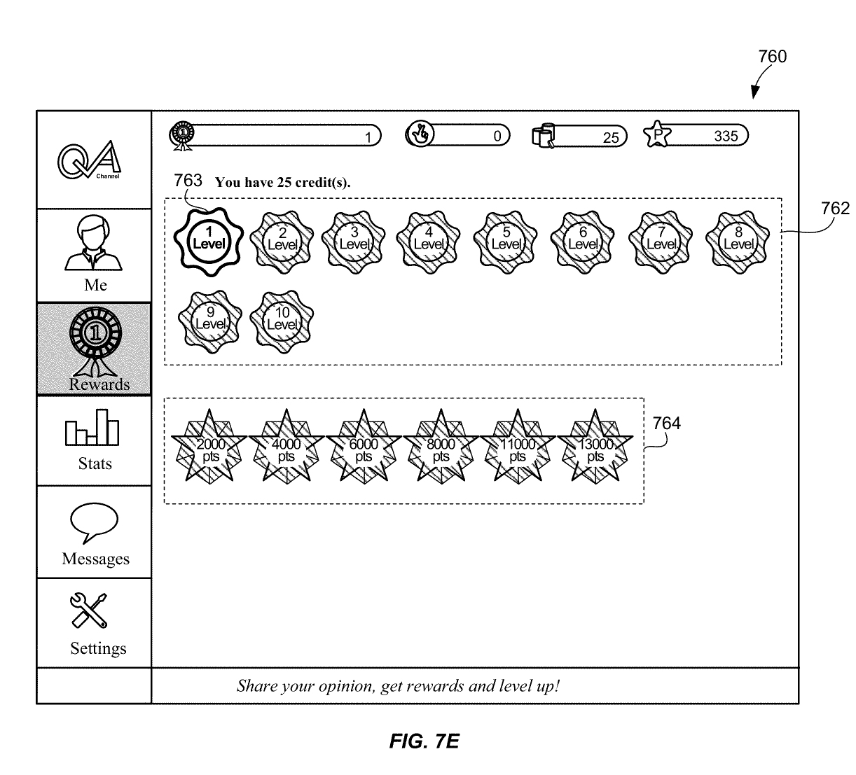

FIG. 7A illustrates a computer generated interface 700 for consuming customized electronic tasks according to a first embodiment. The interfaces depicted and discussed with reference to FIGS. 7A to 7C may be generated by one or more elements of system 100 or system 200, or may be generated by one or more elements of systems not depicted herein. In the following discussion, the interfaces are discussed as being generated by social networking web site 291 (FIG. 2) for display to and input from end users 222. However, embodiments of the invention are not so limited some as all of the elements of the interfaces may be generated by servers, systems, devices, or entities other than social networking web site 291, such as host web site 281.

Computer generated interface 700 may include options for allowing an end user 222 to consume electronic tasks and manage a user account associated with end user 222. Interface 700 may be generated by social networking web site 291 for display to an end user 222. For example, components of interface 700 may be hosted on a web server such as social networking web site 291 or host web site 281 and remotely accessed by end users 222 using electronic computing devices associated with end user 222. Interface 700 may be displayed on a display element of electronic computing devices associated with end user 222 (e.g., I/O element 118 or a display element of end user computing device 220), and end users 222 may provide inputs into interface 700 via an input element of the electronic computing devices associated with end users 222 (e.g., I/O element 118 or an input element of end user computing device 220).

In one embodiment, interface 700 includes selectable options 710. Selectable options 710 include a home window 711, user information 712, rewards information 713, statistics 714, messages 715, and/or settings 716. Options 710 are displayed as inline frames (iframes), but embodiments of the invention are not so limited, as options 710 may be provided as any selectable input element such as a tab, hyperlink, drop-down menu, radio button, etc.

Upon selection of home window 711, various information regarding tasks may be generated and displayed. For example, indicators 720 of customized electronic tasks available for engagement by the user may be displayed. Indicators 720 may be provided in any suitable format, such as a window, a hyperlink, etc. Indicators 720 may be individually selectable by the user, such that the user may independently engage in one or more customized electronic tasks. Each indicator 720 may provide various information concerning the customized electronic tasks available. For example, an indicator 720 may display a company logo 721 associated with the content managing entity that provided the task, a company name 722 associated with the content managing entity that provided the task, and/or a textual description 723 of the task.

Other types of information may also be provided upon selection of home window 711. For example, reward information 725 may be displayed to the user, where the reward information 725 may include information indicating the type and amount of rewards that the user has accumulated.

FIG. 7B illustrates a computer generated interface 730 for editing user preferences in accordance with at least one embodiment. Computer generated interface 730 may include options for allowing end users 222 to view and set user information and preferences. Similar to computer generated interface 700 (FIG. 7A), computer generated interface 730 may be generated by social networking web site 291 for display to an end user 222. In some embodiments, computer generated interface 730 may be generated and displayed to end user 222 as a result of option 712 (FIG. 7A) being selected.

In one embodiment, computer generated interface 730 may display a summary 732 of user information, such as a user name and an image associated with the user. Computer generated interface 730 may also or alternatively display user characteristics 734, which the user may select and alter at their discretion. For example, the user may indicate whether they own pets, whether they have kids, whether they eat healthy food, etc. In some embodiments, the user selection of such characteristics may be provided to electronic task system 120/210 and subsequently used for targeting customized electronic tasks.

FIG. 7C illustrates a computer generated interface 740 for viewing a reward summary in accordance with at least one embodiment. Computer generated interface 740 may include summaries of rewards that a user has earned as a result of engaging customized electronic tasks. Similar to computer generated interface 700 (FIG. 7A), computer generated interface 740 may be generated by social networking web site 291 for display to an end user 222. In some embodiments, computer generated interface 740 may be generated and displayed to end user 222 as a result of option 713 (FIG. 7A) being selected.

In one embodiment, computer generated interface 740 may display, for each type of reward available, a selectable summary of each award. The selectable reward summaries may include one or more of a selectable points summary 741, a selectable credits summary 742, a selectable badges summary 743, a selectable coupons summary 744, a selectable sweepstakes entries summary 745, and a selectable loyalty cards summary 746. Each selectable reward summary may display the total amount of rewards earned. For example, the selectable coupons summary 744 may display a total number of coupons earned 748 as two. Further, upon selection of one of the selectable reward summaries, details on the rewards earned may be displayed.

FIG. 7D illustrates a computer generated interface 750 for viewing details of earned rewards in accordance with at least one embodiment. Computer generated interface 750 may include details of rewards that a user has earned as a result of engaging customized electronic tasks, and/or rewards that a user may purchase or otherwise transfer value to acquire. Similar to computer generated interface 700 (FIG. 7A), computer generated interface 750 may be generated by social networking web site 291 for display to an end user 222. In some embodiments, computer generated interface 750 may be generated and displayed to end user 222 as a result of a selectable reward summary (e.g., selectable coupons summary 744 of FIG. 7C) being selected.

In one embodiment, computer generated interface 750 may display earned coupons 752, which may be coupons that were directly earned by the user as a result of engaging one or more customized electronic tasks or purchased by the user via the transfer of credit. Computer generated interface 750 may also or alternative display purchasable coupons 754, which may be coupons that the user may purchase via the use of credits or other types of rewards. The cost 756, such as one thousand two hundred credits, may be displayed with the purchasable coupon 754. In some embodiments, an available reward 758 that may be used for purchasing a coupon (e.g., the number of credits earned by the user) may also be displayed.

FIG. 7E illustrates a computer generated interface 760 for viewing level achievements and point achievements in accordance with at least one embodiment. Computer generated interface 760 may include levels that a user has achieved as a result of engaging tasks, and/or point levels that the user has achieved as a result of engaging tasks. Similar to computer generated interface 700 (FIG. 7A), computer generated interface 760 may be generated by social networking web site 291 for display to an end user 222. In some embodiments, computer generated interface 760 may be generated and displayed to end user 222 as a result of a selectable reward summary (e.g., selectable points summary 741 of FIG. 7C) being selected.

In one embodiment, computer generated interface 760 may display level indicators 762, which may be indicators indicating a current level of the user and available levels which the user may achieve by, for example, engaging in additional electronic tasks. The level indicators 762 may include an active indicator 763 indicating the current level of the user. Computer generated interface 760 may also or alternatively display point indicators 764, which may be indicators indicating when the user has achieved a certain number of points. Similar to level indicators 762, point indicators 764 may also include an active indicator (not shown) indicating point achievements of the user.

As previously discussed, different types of levels may be provided. In such a case, different types of levels may be displayed by computer generated interface 760, such as a sequence of levels that increases upon engagement with tasks provided by a particular content managing entity 230, and a sequence of levels that increases upon a users engagement with tasks provided by any content managing entity. Similarly, different types of point achievements may also be displayed.

It should be appreciated that the specific graphical interface illustrated in FIGS. 7A to 7E provide graphical interfaces for consuming electronic tasks, according to certain embodiments of the present invention. Other graphical interfaces, elements of graphical interfaces, arrangements of information on graphical interfaces, and the like may also be used according to alternative embodiments. Moreover, graphical interface elements may be added or existing shown graphical interface elements removed depending on the particular applications. Accordingly, one of ordinary skill in the art would recognize and appreciate many variations, modifications, and alternatives.

In some embodiments, a user may engage with the electronic task server or system via an end user computing device such as a mobile phone. In some cases, the mobile phone may have an application installed thereon for interfacing and communicating with the electronic task server or system. In other cases, the mobile phone may have an application stored thereon for interacting with a social networking service, such a Facebook™. Via the end user computing device, the user may then engage with the electronic task server or system. The end user computing device may provide the user with a graphical interface via which the user may receive customized electronic tasks destined for the user, and engage with those tasks. The graphical interface may also provide the user with other options related to the provision of electronic tasks, such as a user profile, reward information, statistics regarding the user's account, and the like.

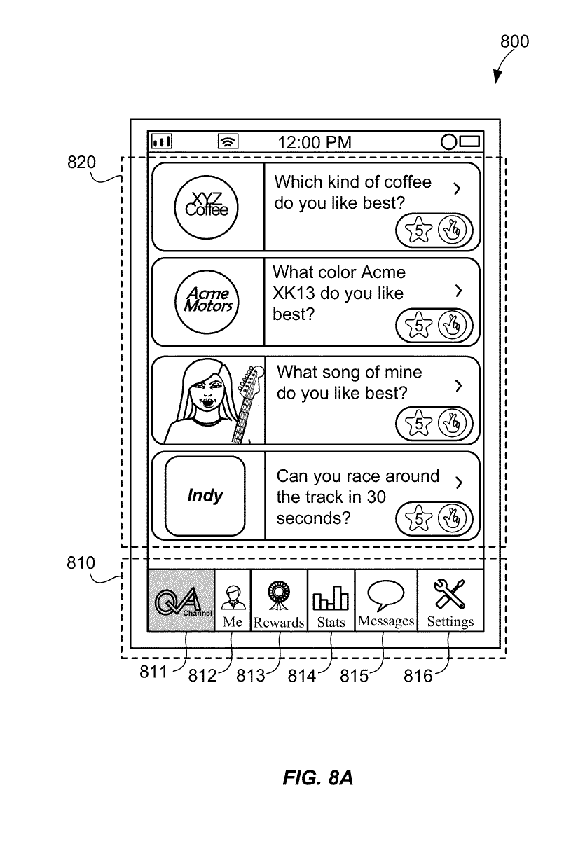

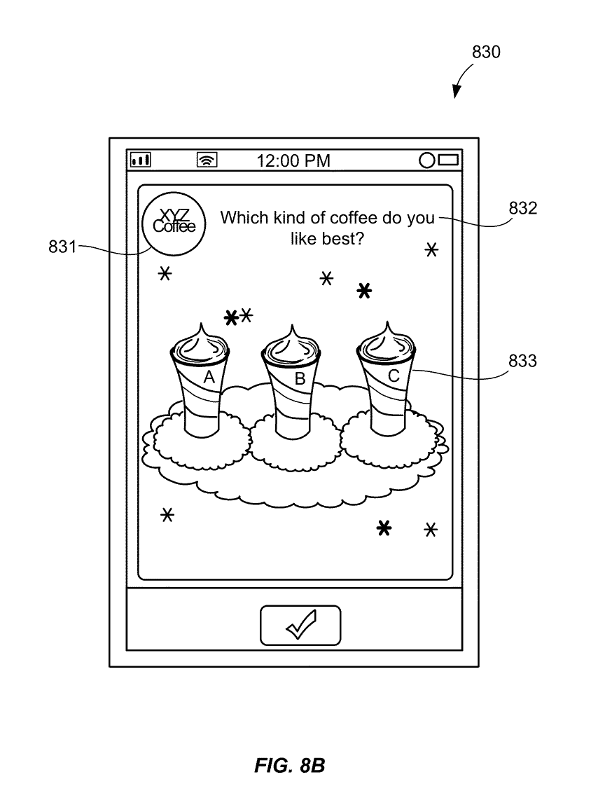

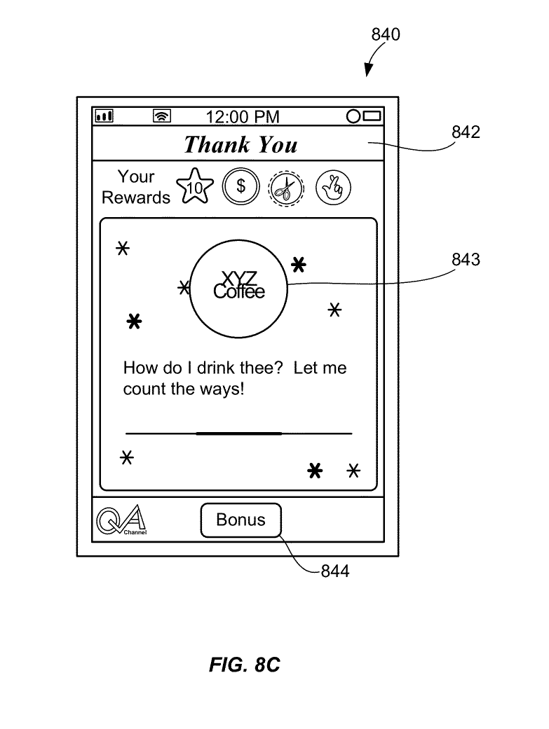

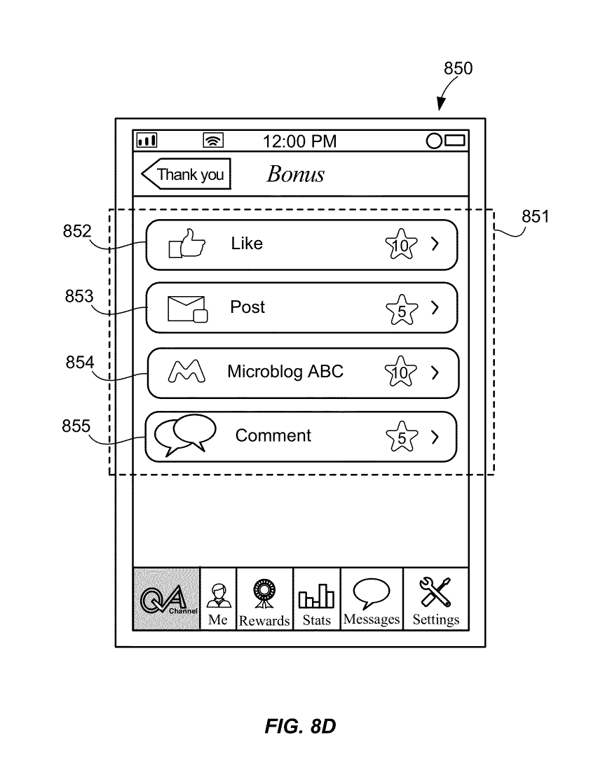

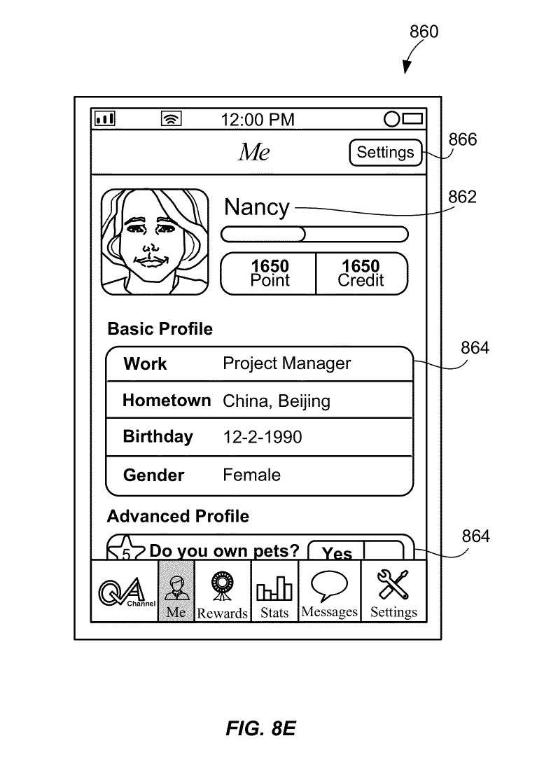

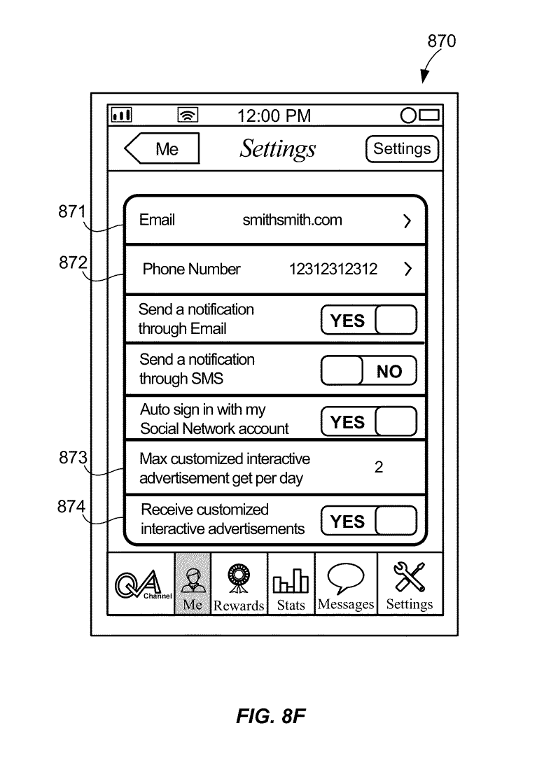

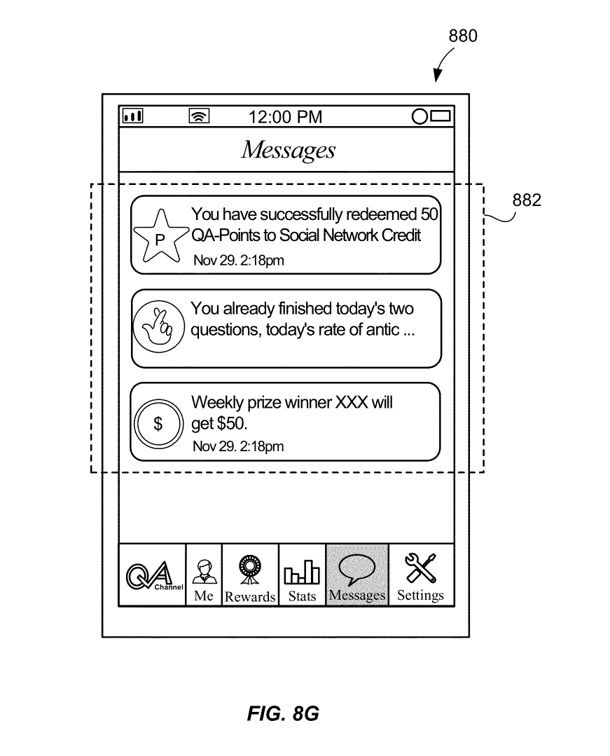

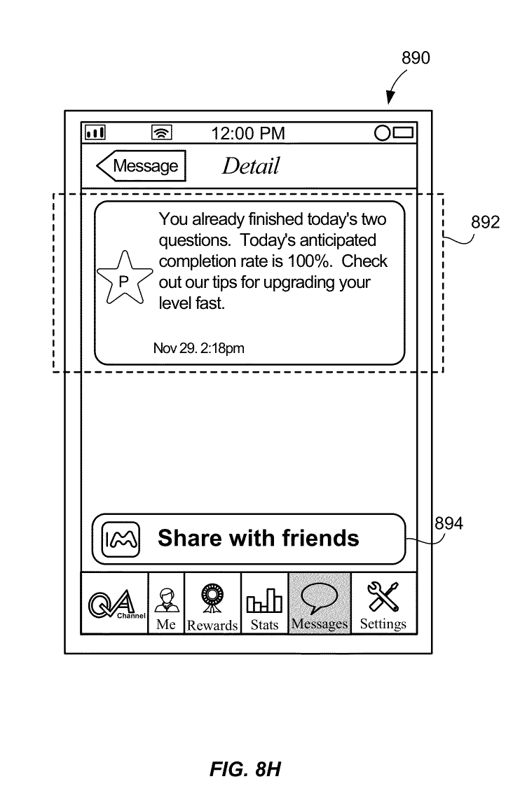

FIG. 8A illustrates a computer generated interface 800 for consuming customized electronic tasks according to a second embodiment. The interfaces depicted and discussed with reference to FIGS. 8A to 8H may be generated by one or more elements of system 100 or system 200, or may be generated by one or more elements of systems not depicted herein. In the following discussion, the interfaces are discussed as being generated by end user computing device 110(a)/220 (FIGS. 1 and 2) for display to and input from end users 222. However, embodiments of the invention are not so limited some as all of the elements of the interfaces may be generated by servers, systems, devices, or entities other than end user computing device 110(a)/220.

Computer generated interface 800 may include options for allowing an end user 222 to consume electronic tasks and manage a user account associated with end user 222. Interface 800 may be generated by end user computing device 110(a)/220 for display to an end user 222. For example, components of interface 800 may be stored in storage elements of end user computing device 110(a)/220 such as storage element 116 and displayed and accessed using input/output elements of end user computing device 110(a)/220 such as I/O element 118.

In one embodiment, interface 800 includes selectable options 810 similar to selectable options 710 discussed with reference to FIG. 7A. Selectable options 810, similar to selectable options 810, may include a home window 811, user information 812, rewards information 813, statistics 814, messages 815, and settings 816. The operation of options 810 is similar to operations 710 discussed with reference to FIG. 7A, and thus further discussion is omitted. Further similar to indicators 720 of customized electronic tasks available for engagement as discussed with reference to FIG. 7A, indicators 820 of customized electronic tasks available for engagement by the user may be displayed by interface 800. The operation of indicators 820 is similar to indicators 720 discussed with reference to FIG. 7A, and thus further discussion is omitted.

FIG. 8B illustrates a computer generated display 830 showing a survey-type customized electronic task in accordance with at least one embodiment. Computer generated display 830 may display a customized electronic task including passive elements for display (such as a company logo 831 and question 832) and active elements operable to receive user input (such as selectable images 833 representing answers to the question).

Various information displayed in computer generated display 830 may be provided by the entity (e.g., a content managing entity 230) responsible for creating the customized electronic task. For example, content managing entity 230 may have customized a survey template by uploading logo 831, the content of question 832, and the images 833, to electronic task system 120/210. The compiled customized electronic task may then be communicated to end user computing device 110(a)/220 for display to end user 222. End user 222 may engage with the customized electronic task by answering the question posed. For example, images 833 may be selectable, such that the user may select one of images 833 to indicate their answer to the question posed. The result may then be communicated back to electronic task system 120/210 for determining an amount and type of rewards to issue to the user.

FIG. 8C illustrates a computer generated display showing a thank you screen and an option to engage in an additional customized electronic task in accordance with at least one embodiment. Computer generated display 840 may display passive elements such as a message 842 thanking the user for their engagement with the task, and a logo 843, where message 842 and logo 843 may have previously been uploaded by content managing entity 230 similar to the passive elements discussed with reference to FIG. 8B. Computer generated display 840 may also display a selectable bonus option 844, selection of which allow the user to engage in one or more additional customized electronic tasks. Similar to computer generated interface 800 (FIG. 8A), computer generated display 840 may be generated by end user computing device 110(a)/220 for display to an end user 222. In some embodiments, computer generated display 840 may be generated and displayed to end user 222 as a result of a user partially or fully completing an engagement with a customized electronic task. For example, computer generated display 840 may be generated and displayed to end user 222 as a result of the user selecting one of images 833 (FIG. 8B).

FIG. 8D illustrates a computer generated display 850 showing an additional customized electronic task in accordance with at least one embodiment. Computer generated display 850 may display further activities which the user may engage in to earn rewards. The further activities may include communication concerning the initial electronic task, such as the user's answer to a question or survey, to other parties. For example, computer generated display 850 may include selectable links 851, selection of which cause information concerning the initial electronic task to be communicated to other parties. Selectable links 851 may include one or more of a like link 852, a post link 853, a tweet link 854, and a comment link 855.

Selection of like link 852 may cause information concerning the initial electronic task to be communicated together with an indication of the user's likeness for the initial task for display on, for example, an account associated with the user and maintained by a social networking web site such as social networking web site 291 (FIG. 2). Selection of post link 853 may cause information concerning the initial electronic task to be communicated for display on, for example, an account associated with the user and maintained by a social networking web site. Selection of tweet link 854 may cause information concerning the initial electronic task to be communicated for display on, for example, an account associated with the user and maintained by a social networking web site such as Twitter™. Selection of comment link 855 may allow the user to enter comments concerning the initial electronic task to be communicated for display on, for example, an account associated with the user and maintained by a social networking web site.

In some embodiments, computer generated display 850 may display an additional customized electronic task, where the additional customized electronic task may be a customized task similar to that discussed with reference to FIG. 8B. The additional customized electronic task may have been created by the same entity such as a particular content managing entity 230 as the original customized electronic task, by a partner of the content managing entity 230, or by an unrelated entity.

FIG. 8E illustrates a computer generated interface 860 for viewing user information in accordance with at least one embodiment. Computer generated interface 860 may include options for allowing end users 222 to view and set user information and preferences. Similar to computer generated interface 800 (FIG. 8A), computer generated interface 860 may be generated by end user computing device 110(a)/220 for display to an end user 222. In some embodiments, computer generated interface 860 may be generated and displayed to end user 222 as a result of option 812 (FIG. 8A) being selected.

In one embodiment, computer generated interface 860 may display a summary 862 of user information, such as a user name and an image associated with the user, similar to summary 732 discussed with reference to FIG. 7B. Computer generated interface 860 may also or alternatively display user characteristics 864, which the user may select and alter at their discretion, similar to user characteristics 734 discussed with reference to FIG. 7B. Summary 862 and user characteristics 864 are similar to those discussed with reference to FIG. 7B, and thus further discussion is omitted. In one embodiment, further to summary 862 and user characteristics 864, computer generated interface 860 may include a settings option 866, selection of which may allow the user to view and/or change preferences associated with the user.

FIG. 8F illustrates a computer generated interface 870 for viewing and setting user preferences in accordance with at least one embodiment. Similar to computer generated interface 800 (FIG. 8A), computer generated interface 870 may be generated by end user computing device 110(a)/220 for display to an end user 222. In some embodiments, computer generated interface 870 may be generated and displayed to end user 222 as a result of settings option 866 (FIG. 8E) being selected.

In one embodiment, computer generated interface 870 may display one or more user preferences that may be set by the user and stored in the account associated with the user. For example, the user preferences may be stored in buy side system 260. The user preferences may include any suitable preferences, such as an email address 871 associated with the user, a phone number 872 associated with the user, a maximum number of customized electronic tasks to receive per day 873, and an agreement to receive customized electronic tasks 874. In some embodiments, user preferences may be set by entities other than user. For example, system managers 240 may set the maximum number of customized electronic tasks per day 873 preference. In some embodiments, user preferences may be used by electronic task system 120/210 in delivering tasks to the user. For example, electronic task system 120/210 may communicate tasks to the user only if the user has agreed to accept tasks as set by the agreement preference 874.

FIG. 8G illustrates a computer generated display 880 showing indicators of messages available for display in accordance with at least one embodiment. Similar to computer generated interface 800 (FIG. 8A), computer generated display 880 may be generated by end user computing device 110(a)/220 for display to an end user 222. In some embodiments, computer generated display 880 may be generated and displayed to end user 222 as a result of option 814 (FIG. 8A) being selected.

In one embodiment, computer generated display 880 may display indicators 882 of one or more messages that have been communicated for the user's consumption. The messages may be any message suitable for display to the user, and may include text, images, video, or other forms of data for display or consumption by the user. The messages may be generated from any suitable entity, such as electronic task system 120/210, content managing entities 230, system managers 240, etc. Display indicators 882 may display various amounts of the content of a message. For example, they may display the entire message, a part of the message, or none of the message. In some embodiments, display indicators 882 may be selectable, such that a user selection of a display indicator results in the message associated with display indicator 882 being displayed.

FIG. 8H illustrates a computer generated display 890 showing details of a selected message in accordance with at least one embodiment. Similar to computer generated interface 800 (FIG. 8A), computer generated display 890 may be generated by end user computing device 110(a)/220 for display to an end user 222. In some embodiments, computer generated display 890 may be generated and displayed to end user 222 as a result of one of display indicators 882 (FIG. 8G) being selected.

In one embodiment, computer generated display 890 may display detailed message information 892 corresponding to a selected message indicator. Detailed message information 892 may include text, images, video, or other types of data for display to or consumption by the user. In some embodiments, one or more links 894 may be provided enabling the user to communicate some or all of detailed message information 892 to other parties, similar to selectable links 851 discussed with reference to FIG. 8D.

It should be appreciated that the specific graphical interface illustrated in FIGS. 8A to 8H provide graphical interfaces for consuming electronic tasks, according to certain embodiments of the present invention. Other graphical interfaces, elements of graphical interfaces, arrangements of information on graphical interfaces, and the like may also be used according to alternative embodiments. Moreover, graphical interface elements may be added or existing shown graphical interface elements removed depending on the particular applications. Accordingly, one of ordinary skill in the art would recognize and appreciate many variations, modifications, and alternatives.

The operations described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

The use of the terms “a” and “an” and “the” and similar referents in the context of describing embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope unless otherwise claimed. No language in the specification should be construed as indicating any non-claimed element as essential to the practice of at least one embodiment.

Preferred embodiments are described herein, including the best mode known to the inventors. Variations of those preferred embodiments may become apparent to those of ordinary skill in the art upon reading the foregoing description. The inventors expect skilled artisans to employ such variations as appropriate, and the inventors intend for embodiments to be constructed otherwise than as specifically described herein. Accordingly, suitable embodiments include all modifications and equivalents of the subject matter recited in the claims appended hereto as permitted by applicable law. Moreover, any combination of the above-described elements in all possible variations thereof is contemplated as being incorporated into some suitable embodiment unless otherwise indicated herein or otherwise clearly contradicted by context. The scope of the invention should, therefore, be determined not with reference to the above description, but instead should be determined with reference to the pending claims along with their full scope or equivalents.

What is claimed is:

1. A computer-implemented method of sourcing electronic tasks, comprising:
obtaining, by one or more computer systems, customized electronic tasks, each customized electronic task being customized for a corresponding content managing entity;
identifying, by the one or more computer systems, a plurality of users that selected to participate in receiving customized electronic tasks;
communicating, by the one or more computer systems, one or more of the customized electronic tasks to at least one of the identified plurality of users; and
receiving feedback information indicating an engagement with the customized electronic tasks by the users for determining a reward to be issued to the users.

2. The computer-implemented method of claim 1, wherein each customized electronic tasks is customized to promote a brand of goods or services.

3. The computer-implemented method of claim 1, wherein identifying the plurality of users includes one or more of:
receiving user information indicating the identity of a user during a user registration process; and
detecting execution of the end user application.

4. The computer-implemented method of claim 1, further comprising:
acquiring demographic information concerning the plurality of users;
wherein the customized electronic tasks are communicated to the identified users based on the demographic information concerning the identified users.

5. The computer-implemented method of claim 1, wherein the customized electronic tasks are selected from the group consisting of: a question, a survey, an action, and a game.

6. The computer-implemented method of claim 1, further comprising:
determining an amount and type of rewards to assign to the identified user based on the received feedback information; and
crediting an account associated with the identified user based on the determined amount of rewards.

7. The computer-implemented method of claim 6, further comprising:
increasing a level associated with the identified user based on an amount of rewards accumulated by the identified user; and
setting the amount of rewards assigned to the identified user based on the level associated with the identified user.

8. The computer-implemented method of claim 6, wherein rewards includes at least one of rewards unique to the content managing entity and rewards common to all participating content managing entities.

9. The computer-implemented method of claim 6, wherein rewards are selected from the group consisting of: points, credits, badges, coupons, sweepstake entries, and loyalty cards.

10. The computer-implemented method of claim 1, wherein receiving customized electronic tasks includes:
receiving a user input indicating the type of customized electronic task to be generated;
displaying a plurality of templates corresponding to the indicated customized electronic task type;
receiving a selection of one of the templates; and
receiving customization information for customizing the selected template.

11. The computer-implemented method of claim 1, further comprising:
stopping communication of a customized electronic task if a condition has been satisfied.

12. The computer-implemented method of claim 11, wherein the condition includes one or more of: communication of the electronic customized electronic task to a maximum number of identified users; reception of feedback information for the customized electronic task from a maximum number of identified users; issuance of a maximum amount of rewards for the customized electronic task; and expiration of a time duration.

13. The computer-implemented method of claim 1, wherein communicating the customized electronic tasks includes causing the customized electronic tasks to be displayed on user devices associated with the identified users.

14. The computer-implemented method of claim 1, wherein the content managing entity includes one or more of a creative agency, a pollster, a surveyor, an advertiser, an agency, a business manager, and an administrator.

15. A tangible non-transitory computer readable storage medium including instructions stored thereon that, when executed, cause a computing device or system of computing devices to perform operations including:
displaying one or more indicators of customized electronic tasks to a user, the user having selected to participate in receiving customized electronic tasks;
receiving a user selection of one of the customized electronic task indicators; and
generating feedback information regarding the selected customized electronic task indicator, the feedback information indicating an engagement with the selected customized electronic task by the user.

16. The computer readable storage medium of claim 15, wherein the instructions, when executed, cause the computing device or system of computing devices to perform operations further including:
displaying a request for login information; and
receiving login information from the user, the login information identifying the user from a plurality of users;
wherein the customized electronic tasks are displayed based on the login information.

17. The computer readable storage medium of claim 15, wherein the instructions, when executed, cause the computing device or system of computing devices to perform operations further including:
displaying an option to engage in an additional electronic task related to the customized electronic task; and
generating additional feedback information based on a user selection of the option to engage in an additional electronic task.

18. A system for sourcing electronic tasks, comprising:
a processor operable to identify a plurality of users that selected to participate in receiving customized electronic tasks, each customized electronic task being customized for a corresponding content managing entity;
a communication interface operable to receive customized electronic tasks; and
a storage element operable to store the customized electronic tasks;
wherein the communication interface is further operable to communicate one or more of the customized electronic tasks to at least one of the identified plurality of users.

19. The system of claim 18, wherein each customized electronic task is customized to promote a brand of goods or services.

20. The system of claim 18, wherein receiving customized electronic tasks includes:
receiving a user input indicating the type of customized electronic task to be generated;
communicating a plurality of templates corresponding to the indicated customized electronic task type;
receiving a selection of one of the templates; and
receiving customization information for customizing the selected template.
